(19) United States
(12) Patent Application Publication
(10) Pub. No.: US 2018/0135987 A1
(43) Pub. Date: May 17, 2018

(54) AUTOMATICALLY RECOMMENDING CHANGES TO WHEELCHAIR SETTING BASED ON USAGE DATA

(71) Applicants: Redliner Inc., Calgary (CA); The Governors of the University of Alberta, Edmonton (CA)

(72) Inventors: David Richard Evans, Calgary (CA); Martin William Ferguson-Pell, Edmonton (CA); Zohreh Salimi, Edmonton (CA)

(21) Appl. No.: 15/812,558

(22) Filed: Nov. 14, 2017

Related U.S. Application Data
(60) Provisional application No. 62/421,684, filed on Nov. 14, 2016.

(51) Int. Cl. G01C 21/20; A61G 5/04; A61G 5/06

(52) U.S. Cl. CPC G01C 21/20; A61G 5/04; A61G 2203/42; A61G 2203/12; A61G 2203/36; A61G 5/06

(57) ABSTRACT

A system for recommending changes to a wheelchair configuration setting includes a portable electronic device having at least one sensor collecting a plurality of sensor data corresponding to movement of a wheelchair. One or more processors are coupled to a storage device and a communication interface. By the one or more processors executing software instructions loaded from the storage device, the one or more processors are operable to receive the sensor data from the portable electronic device via the communication interface, and generate a recommended wheelchair setting for the wheelchair based at least in part on the sensor data. The processors compare the recommended wheelchair setting with a current wheelchair setting associated with the wheelchair stored in the storage device, and transmit a setting change message via the communication interface when the recommended wheelchair setting is different than the current wheelchair setting.

### CROSS-REFERENCE TO RELATED APPLICATIONS

This application claims the benefit of priority of U.S. Provisional Application No. 62/421,684 filed Nov. 14, 2016, which is incorporated herein by reference.

### BACKGROUND OF THE INVENTION

### (1) Field of the Invention

The invention pertains generally to wheelchairs. More specifically, the invention relates to monitoring usage of a wheelchair with one or more sensors to automatically recommend adjustments to one or more settings such as the rear axle position.

### (2) Description of the Related Art

Many factors need to be considered when selecting and configuring a new wheelchair. Normally these factors involve the judgement of both the end user and their clinician. Together, the parties weigh the importance of degree of trunk control during propulsion, the level of experience the wheelchair user has propelling their wheelchair, the environment the wheelchair is used in, whether the user needs and can “pop wheelies” to negotiate curbs, where the user's centre of gravity is located (determined by posture, rear axle position and build), and also the magnitude of propulsion forces generated during normal wheelchair use.

The correct adjustment of a wheelchair is important to ensure the user can function fully and to improve the efficiency of propulsion. One important adjustment involves the position of the rear axle (front to back). An incorrect rear axle setting can render the wheelchair unstable on slopes and/or when accelerating the wheelchair rapidly. If the rear axle is too far back, it can be very difficult to get the front wheels to lift off the ground. This tends to cause the wheelchair user to easily get stuck and require help from other people. Alternatively, if the rear axle is too far forward, the chair is much easier to tip backwards. More experienced users will lean forward on hard pushes to avoid the chair tipping backwards, but an inexperienced user could cause the chair to tip backwards and fall by pushing too hard when the rear axle is in a more forward position.

When providing a new wheelchair, the clinician will typically interview the wheelchair user regarding the above-described factors. The most appropriate wheelchair will then be selected and configured with the appropriate rear axle setting to best match the skill level and requirements of the user.

One problem with the typical wheelchair selection and configuration process described above is that it is often only performed initially at the time of acquiring the new wheelchair. This means the wheelchair in general and the rear axle position setting in particular may not be suitable given later changes in either the user's experience level or desired usage environments. Although it is possible for the user to return to the clinician for one or more follow-up appointments to review how things are going with the new chair, these follow-up discussions are costly and inconvenient.

Another problem with the typical wheelchair selection process is that the user and clinician may not be able to properly select and configure the wheelchair based only on verbal discussions. This applies to both the initial meetings and any follow-up appointments. For instance, a wheelchair user may not report difficulty negotiating minor obstacles out of embarrassment without realizing they could overcome these problems if the rear axle setting were just changed to a more forward position.

### BRIEF SUMMARY OF THE INVENTION

One or more portable activity monitors for wheelchair users are disclosed according to an exemplary embodiment to provide useful information in determining correct wheelchair setup. The portable activity monitors may provide a number of inputs to an algorithm that generates recommended wheelchair settings and helps inform the wheelchair user and/or the clinician as to how best to set up the wheelchair. One or more neural networks and/or other algorithms balance any number of desired input factors such as activity level, expected terrain to be traversed, experience level of the user, actual usage, etc. to recommend the wheelchair setup best suited for the individual user. A beneficial input to the neural network algorithm in some embodiments is activity and propulsion force and other information gathered during the normal usage environment of the wheelchair. In some embodiments, an adaptive neural network is embedded within a web based dashboard, or as part of a wheelchair activity monitoring application (app) operating on a mobile device such as the user's mobile phone. Activity and propulsion force information in conjunction with other parameters are synthesized dynamically by the adaptive neural network as the dashboard is populated by data generated by the user as they go about their everyday wheelchair propulsion activities.

As the wheelchair user becomes more proficient, or active or possibly loses function if they have a degenerative condition, then the recommended wheelchair setup is automatically adjusted by the system and can be reviewed by the user or their clinician at any time. Actual usage data may be made available via an online portal dashboard. Setting change messages are automatically generated by the dashboard and transmitted to the user and/or their clinician. In some embodiments, data is also collected in a repository such as a user database stored in the cloud that can be used to enhance knowledge about optimal wheelchair setup and design with the view to reducing the effort needed to use a wheelchair in non-clinical settings.

According to an exemplary embodiment of the invention there is disclosed a system for recommending changes to a wheelchair configuration setting. The system includes a portable electronic device having at least one sensor collecting a plurality of sensor data corresponding to movement of a wheelchair. One or more processors are coupled to a storage device and a communication interface. By the one or more processors executing software instructions loaded from the storage device, the one or more processors are operable to receive the sensor data from the portable electronic device via the communication interface, and generate a recommended wheelchair setting for the wheelchair based at least in part on the sensor data.

According to an exemplary embodiment, the processors further compare the recommended wheelchair setting with a current wheelchair setting associated with the wheelchair, and transmit a setting change message via the communication interface when the recommended wheelchair setting is different than the current wheelchair setting.

According to an exemplary embodiment of the invention there is disclosed a method of recommending changes to a wheelchair configuration setting. The method includes collecting a plurality of sensor data corresponding to movement of a wheelchair, and generating a recommended wheelchair setting for the wheelchair based at least in part on the sensor data.

According to an exemplary embodiment, the method further includes comparing the recommended wheelchair setting with a current wheelchair setting associated with the wheelchair, and transmitting a setting change message via a communication interface when the recommended wheelchair setting is different than the current wheelchair setting.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a system for recommending changes to a wheelchair configuration setting according to an exemplary embodiment.

FIG. 2 shows a side view of a wheelchair with the sensor system of FIG. 1 mounted to spokes of one of the rear wheels according to an exemplary embodiment.

FIG. 3 is a conceptual diagram illustrating an example board layout of a sensor system according to an exemplary embodiment.

FIG. 4 is side view showing a technique for attaching the sensor system of FIG. 1 to a wire spoke wheelchair wheel according to an exemplary embodiment.

FIG. 5 shows a flowchart of operations performed by the sensor system of FIG. 1 according to an exemplary embodiment.

FIG. 6 shows a flowchart of operations performed by the mobile phone of FIG. 1 according to an exemplary embodiment.

FIG. 7 shows a flowchart of operations performed by the monitoring server of FIG. 1 according to an exemplary embodiment.

FIG. 8 illustrates a web-based dashboard user interface (UI) screen generated by the webserver of FIG. 1 providing a graph of a user's activity levels and a recommend rear axle position (RAP) setting according to an exemplary embodiment.

FIG. 9 shows a first route planning UI screen providing the user with a recommended route that is compatible in difficulty level with the user's current RAP setting according to an exemplary embodiment.

FIG. 10 shows a second route planning UI screen warning the user that a predetermined route involves changing to a recommended RAP setting higher than the user's current RAP setting according to an exemplary embodiment.

FIG. 11 illustrates a first side view of a universal mounting system for attaching the sensor system of FIG. 1 to the wheel of a wheelchair according to an exemplary embodiment.

FIG. 12 illustrates a top view of the universal mounting system of FIG. 11.

FIG. 13 illustrates a front view of the universal mounting system of FIG. 11.

FIG. 14 illustrates a second side view of the universal mounting system of FIG. 11.

FIG. 15 shows a UI screen allowing a user to input information that can be utilized by the neural network of FIG. 1 in order to determine recommended wheelchair setting(s) according to an exemplary embodiment.

FIG. 16 shows a UI screen allowing the user to view various representations of the sensor data along with the recommended RAP setting recommended by the neural network of FIG. 1 according to an exemplary embodiment.

FIG. 17 shows a top down view of a servo driven adjustable RAP system according to an exemplary embodiment.

FIG. 18 shows a front on view of the servo driven adjustable RAP system of FIG. 17.

FIG. 19 shows a first side view of a belt driven adjustable RAP system according to an exemplary embodiment.

FIG. 20 shows a second side view of the belt driven adjustable RAP system of FIG. 19.

FIG. 21 illustrates a side view of a wheelchair with a manually adjustable RAP setting.

FIG. 22 illustrates an isometric view of the wheelchair of FIG. 21.

### DETAILED DESCRIPTION

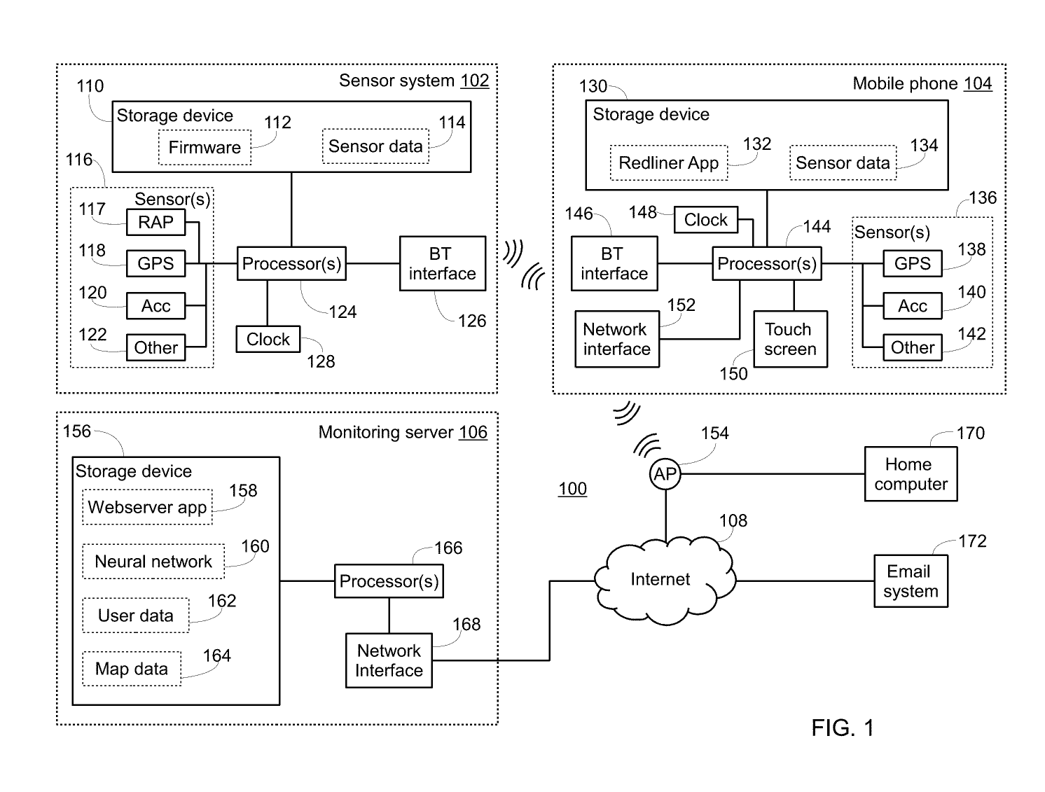

FIG. 1 shows a system 100 for recommending changes to a wheelchair configuration setting according to an exemplary embodiment. The system 100 includes a sensor system 102 acting as a portable activity monitor wirelessly coupled to a mobile phone 104. The mobile phone 104 is coupled to a cloud-based monitoring server 106 via the computer network such as the Internet 108.

The sensor system 102 in this embodiment includes a storage device 110 such as a flash memory device having stored therein firmware 112 and sensor data 114. The sensor data 114 is collected from one of more sensors 116 such as a rear axle position (RAP) sensor 117, a global positioning system (GPS) receiver 118, one or more accelerometers 120, and any number of other sensors 122. The sensor(s) 116 are each coupled to one or more processors 124, which execute the firmware 112 loaded from the storage device 110 in order to perform the below described functions. The one or more processors 124 are further coupled to a Bluetooth (BT) interface 126 for performing wireless communications with remote computing devices, and the processors 124 are also coupled to a clock 128 such as a real time clock chip that is keeps the current time and may be synchronized from one or more clock servers or devices on the Internet 108.

In the following description the singular form of the word “processor” will be utilized for the processor 124 of the sensor system 102 as it is common for an embedded CPU of an embedded computing device to have a single processor 124 (sometimes also referred to as a core); however, it is to be understood that multiple processors 124 may also be configured to perform the described functionality of the sensor system 102 in other implementations. For example, the CPU of the sensor system 102 may be implemented with a multi-core architecture.

The mobile phone includes a storage device 130 which may also be implemented by a flash memory device and stores a software application referred to in this example as a “Redliner” application 132. The Redliner application 132 gets it name because it may be configured in some embodiments to provide alerts when a user's activity level exceeds a predetermined threshold, i.e., to notify the user when they are “redlining”. The Redliner application 132 works in conjunction with sensor data 134 also stored in the storage device 130. The sensor data 134 may include sensor data 114 received from the sensor system 102 and/or may include other data collected from one or more sensors 136 included within the mobile phone 104 itself. Examples of sensors 136 that may be included in the mobile phone 104 include a global positioning system (GPS) receiver 138, one or more accelerometers 140, and any number of other sensors 142. The sensor(s) 136 are coupled to one or more processors 144, which execute the Redliner application 132 loaded from the storage device 130 in order to perform a variety of functions described in more detail below. The one or more processors 144 are further coupled to a Bluetooth (BT) interface 146 for communicating with the sensor system 102, to a touch screen 150 acting as a user interface (UI), and to a network interface 152 such as a WiFi adaptor for communicating with a wireless access point (AP) 154 in order to gain access to the Internet 108.

In the following description the plural form of the word “processors” will be utilized for the one or more processors 144 of the mobile phone 104 as it is common for the CPU of modern smartphone to have multiple processors 144 (sometimes also referred to as cores); however, it is to be understood that a single processor 144 may also be configured to perform the described functionality of the mobile phone 144 in other implementations.

The monitoring server 106 in this embodiment is a cloud-based computer server including a storage device 156 which may be implemented by a combination of magnetic media and flash memory devices for example. The storage device 156 stores a number of software programs and data including a webserver application 158, a neural network 160, a plurality of user data 162, and a plurality of map data 164. The operation and purpose of each are described in further detail below. The monitoring server 106 further includes one or more processors 166 coupled to the storage device 156 and a network interface 168 such as a gigabit Ethernet adaptor for providing access to the Internet 108.

In the following description the plural form of the word “processors” will be utilized for the one or more processors 166 of the monitoring server as it is common for the CPU of computer server to have multiple processors 166 (sometimes also referred to as cores); however, it is to be understood that a single processor 166 may also be configured to perform the described functionality of the monitoring server 106 in other implementations.

The system 100 of FIG. 1 further illustrates a home computer 170 coupled to the access point 154, and an email server 172 coupled to the Internet 108. Although not expressly illustrated in FIG. 1, these computers 170, 172 may also include one ore more processors coupled to a storage device such as a magnetic media, random access memory (RAM), and/or flash memory. Software instructions may be loaded from the storage devices and executed by the one or more processors to perform the operations described below for these devices 170, 172.

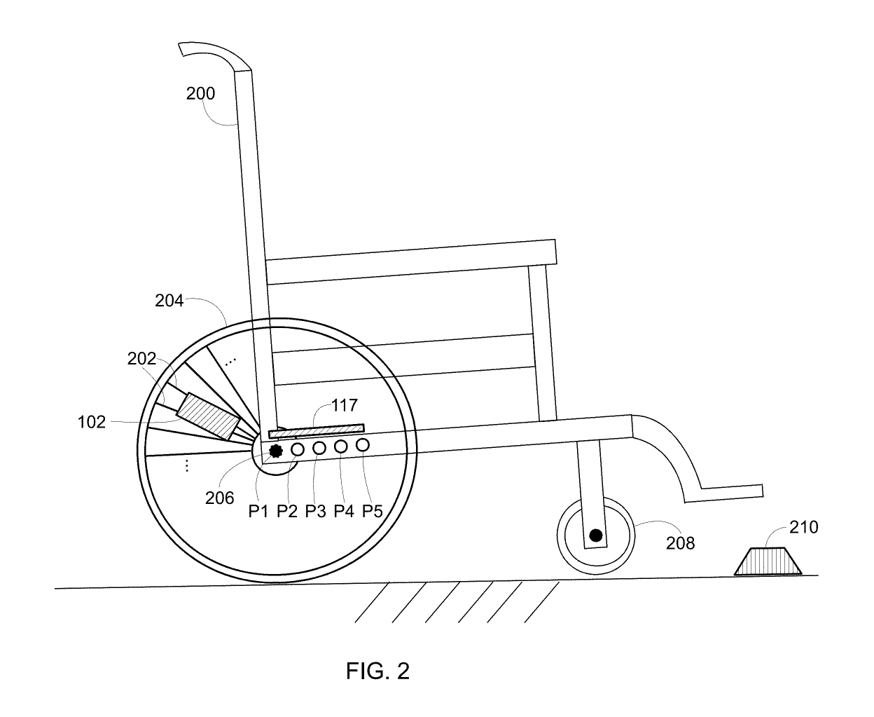

FIG. 2 shows a side view of a wheelchair 200 with the sensor system 102 of FIG. 1 mounted to spokes 202 of one of the rear wheels 204 according to an exemplary embodiment. As illustrated, the rear wheels 204 are supported and rotate around a rear axle 206 currently installed at position P1. In this embodiment, there are a total of five user-selectable rear axle positions: P1, P2, P3, P4, P5. The rear axle 206 may be moved to any of these positions in order to change the stability and efficiency characteristics of the wheelchair 200. For instance, while the rear axle 206 is installed in position P1 as is illustrated in FIG. 2, the rear wheels 204 are mounted furthest back at the maximum distance possible from the front wheels 208. This causes the wheelchair 200 to be very stable at the cost of lowering the propulsion efficiency and making it difficult for the user to raise the front wheels 208 off the ground in order to overcome obstacles 210. If the rear axle 206 is moved to position P5, the rear wheels 204 will be moved to the furthest forward position and it will be much easier for the user to “pop a wheelie” in order raise the front wheels 208 off the ground and get over obstacles 210. The selection of the axle position P1, P2, P3, P4, P5 is referred to herein as the rear axle position (RAP) setting.

In some embodiments, an object of the system 100 is to utilize sensor data 114 collected from the sensor system 102 regarding movement of one or both of the rear wheels 204 to automatically transmit RAP setting change messages. For instance, after the sensor data 114 shows the wheelchair user is gaining experience and beginning to run up against the limits imposed by having the rear axle 206 mounted in position P1, the system 100 will transmit a RAP setting change message to the user and/or the user's clinician that recommends changing to the rear axle 206 to a more advanced position such as one of P2-P5. The system continues to monitor the sensor data 114 in order to detects when additional changes are recommended and to issue additional RAP setting change messages as required. The RAP setting change messages may be sent month by month to give the user time to adjust to each new setting, and/or RAP setting change messages may be sent dynamically in real time such as in response to the system 100 detecting a dangerous setting or condition that requires an immediate RAP setting change.

As shown, the wheelchair 200 may also have one or more RAP sensor(s) 117 installed adjacent to the available positions P1, P2, P3, P4, P5 to monitor the current RAP setting. For example, the RAP sensor 117 may detect into which particular one of the available positions P1, P2, P3, P4, P5 the rear axle 216 is currently installed. The current RAP setting as detected by the RAP sensor 117 is included in the sensor data 114 for transmission to other devices in the system 100 such as the mobile phone 104 and/or the monitoring server 106. In other configurations, the RAP sensor 117 may be omitted and the user may simply input their current RAP setting into a field within the Redliner application 132 running on the mobile phone 104, or into a web form provided by webserver 158 running on the monitoring server 106.

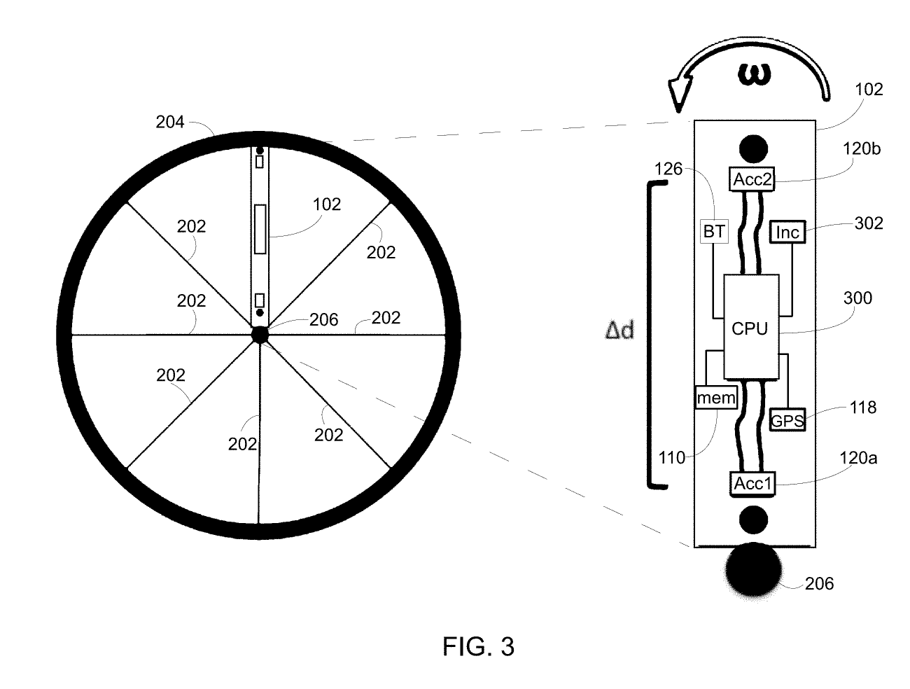

FIG. 3 is a conceptual diagram illustrating an example board layout of a sensor system 102 according to an exemplary embodiment. As illustrated in FIG. 3, the sensor system 102 is mounted to a spoke 202 of the rear wheel 204 and includes a first accelerometer 120a, a second accelerometer 120b, a global positioning system (GPS) receiver 118, a computing device 300 including processor 124, an inclinometer 302, a Bluetooth wireless transceiver 126, and a flash memory storage device 110. In some embodiments, the sensor system 102 may be based on an Application Note by Kionix Inc. comprising two 3-axis accelerometers 202, 204 mounted on a thin profile rigid substrate that also serves to make electrical connections between the sensor components. The sensor system 102 may be supported on any suitable base material such as a substrate made of plastic, which is mountable to the wheel 204 of the wheelchair 150.

In the example illustrated in FIG. 3, the first and second accelerometers 120a, 120b may include 3-axis accelerometers. In other examples the accelerometer 120a and accelerometer 120b may include 2-axis accelerometers. Other or additional sensor(s) 122 may also be included in other embodiments. For instance, an integrated altimeter may be included within sensor system 102 to enable calculating the slope of a surface, rather than or in addition to the inclinometer 302.

As described by Kionix, the distance (Δd) between the accelerometers 120a and 120b should be maximized in some cases to obtain optimal sensitivity. When the wheel 204 rotates with angular velocity ω, the centripetal (radial direction) acceleration experienced by the two accelerometers 120a and 120b is different due to the difference in their distance from the center of rotation (the hub at the rear axle 206 of the wheel 204). For instance, when mounted on the wheel 204 in the position shown in FIG. 3, the first accelerometer 120a is located closer to the inner hub of the wheel 204, and the second accelerator 120b is located closer to the outer rim of the wheel 204. Once the instantaneous angular velocity of the wheel 204 has been determined, it is possible to calculate the change in the acceleration of the wheel 204, and therefore the acceleration of wheelchair 200 that can be attributed to the propulsion force applied by the user, based on Newton's 2^{nd} Law of Motion (Force=mass×acceleration). The force estimated from the acceleration of the wheelchair 200 does account for the opposing force of the rolling resistance or any incline of the surface, and so adjustments for these factors are made both in the instrumentation and the algorithm used to estimate the propulsion force in this configuration.

Although in principle only one accelerometer 120 is needed to estimate the angular velocity of the wheelchair 200, spurious vibrations and impacts detected by a single accelerometer 200 may swamp the propulsion acceleration signal even when filtering techniques are used to detect acceleration signals likely to be in the range of the propulsion forces. By using two accelerometers 120a, 120b, since both experience the same spurious acceleration signals, then the difference between them can be attributed to the difference in centripetal acceleration associated with Δd and ω. However, in other embodiments a single accelerometer 120 is utilized to estimate the angular velocity.

In the example illustrated in FIG. 3, the sensor system 102 includes a GPS receiver 118 and an inclinometer 302. GPS receiver 118 may be configured to receive signals (e.g., three or more satellite time signals) in order to correlate the position of the wheelchair 200. Inclinometer 302 may be configured to measure the angle of the wheelchair. It should be noted that in other examples additional or fewer sensors 116 may be included as part of sensor system 102.

In the example illustrated in FIG. 3, the first and second accelerometers 120a, 120b are in communication with the onboard computing device 300. In one example, the computing device 300 includes a microcontroller and one or more communications transceiver(s). The microcontroller may include the one or more processors 124 operable to execute software instructions such as firmware 112 loaded from an attached memory device such as the flash storage device 110.

In one example, the computing device 300 applies the algorithms and sensor data collection outlined below at a sampling rate of at least 10 Hz. A real time clock 128 included within the computing device 300 (or coupled to computing device 300) may record the timing of the data records and a low energy Bluetooth RF transmitter-receiver 126 may communicate between sensor system 102 and a remote computing device such as the mobile phone 104 illustrated in FIG. 1. Of course, other types of communications interfaces may be employed as desired such as WiFi communications implemented by a WiFi transceiver chip (not shown), or even communications ports for wired connections such as universal serial bus (USB).

In one example, a remote computing device such as a mobile phone 104 is wirelessly coupled to the sensor system 102. In one example, a wrist-worn Bluetooth-enabled sensor or other portable/wearable electronic device may be coupled to the sensor system 102 and/or the mobile phone 104 and utilized to provide alerts. For instance, each time the propulsion force is determined by the Redliner application 132 running on the mobile phone 2014 to be above the “red line” threshold of activity level, the mobile phone 104 sends a signal to the portable/wearable electronic device to case a micro-vibration motor to pulse and provide real-time feedback to the wheelchair user. For instance, the user may feel the wrist or other wearable device buzz upon high exertion detected. The feedback may be intended to encourage the wheelchair user to moderate their propulsion forces and reduce the risk of over-use injury. Various types of alerts may be utilized in different embodiments to provide feedback such as vibrations, audible tones and announcements, visual signals such as warning lights, etc.

Redliner application 132 is an example of an application configured to monitor a wheelchair user's activities according to the techniques described herein. In one example, Redliner application 132 can be downloaded by the user and periodically communicate with the sensor system 102 using either a standard communications protocol or a proprietary Bluetooth protocol developed for the Redliner application 132. Redliner application 132 may provide feedback to the user on recent propulsion events, providing a range of parameters that are indicators of the level of activity and over-exertion. Furthermore, the Redliner application 132 running on the mobile phone 104 or another computer device may act as a bridge to a password protected web-based dashboard on monitoring server 106 where a more comprehensive record of propulsion activity and a long-term archive is maintained for each user in user data 162. Sensor data 134 from the Redliner application 132 may be sent via the Internet 108 or another network to the monitoring server 106 for storage and further processing. Data associated with the archive guidance can be given to indicate if the user's typical propulsion behavior is considered to be in a low medium or high risk for injury category based on data-mining of accumulated records of a large number of users. Specific advice on how to reduce overuse risk may also be provided based on normative data records, such as to advise a user to perform longer stroke-lengths, a less impulsive propulsion technique, or less intensive standing-start pushes.

The sensor system 102 transmits a plurality of sensor data 114 corresponding to information received from the sensors 116 such as accelerometers 120a, 120b and/or other sensor 118, 122 regarding motion of the wheel 204 of the wheelchair 200 over time. In some embodiments, the data transmitted is in real time so that alerts and setting change messages can be issued to the user in real time as exertion by the user reaches predetermined thresholds or new rear axle settings are recommended, for example. The user's exertion is calculated by the Redliner application 132 by first determining one or more wheel-motion values. Examples of different wheel-motion values include wheel velocity, wheel acceleration, and wheel pushes, and algorithms that may be utilized to calculate each by the one or more processors executing the Redliner application 132 are provided in the following.

In one example, Redliner application 132 may be configured to calculate wheel velocity. In one example, angular wheel velocity may be calculated according to Equation 1.

$$ω = \sqrt{\frac{{a}_{x 2} - {a}_{x 1}}{Δ d}} \qquad Equation 1$$

Where aₓ are the measured accelerations along the radial axis, and Δd is the distance between the accelerometers 120a, 120b.

In one example, Redliner application 132 may be configured to calculate wheelchair acceleration. In one example, wheelchair acceleration may be calculated according to Equation 2.

$${a}_{wc} = {r}_{w} \frac{\partial \overline{{ω}_{w}}}{\partial t} \qquad Equation 2$$

Where r_{w} is the radius of the wheelchair wheel, and ω̅_̅{̅w̅}̅ is the moving mean of ω_{w}.

In one example, Redliner application 132 may be configured to detect wheel pushes. In one example, push detection involves analyzing a scrolling window of past wheelchair accelerations and capturing if (and when) the acceleration signal adheres to three criteria:

1. The signal becomes strictly positive. (a_{wc}>0)

2. The signal becomes sufficiently massive. (a_{wc}>aₜₕ)

3. The above two conditions are achieved for a sufficiently lengthy period of time. (tₚ≥tₘᵢₙ)

Once the three criteria are met, a push is detected with its endpoint being the period in time where any one of the criteria fails.

In one example, Redliner application 132 may be configured to estimate rolling resistance. In one example, once a push has been completed, system 100 begins measuring negative acceleration (deceleration) due to the rolling resistance of the surface. Over the periods between active pushes, going back over an adequately sized time window, the mean deceleration may be calculated and used as an indicator of rolling resistance, (a_{R}).

In one example, Redliner application 132 may be configured to calculate output parameters. Example output parameters include:

1. Start time of the packet.

2. The sum of the distance traveled by the pushes, calculated as by, e.g.:

Σₙ₌₁^{N}r_{w}∫₀^{t}^{_{p,n}}ω_{w,n}dt

Where tₚ is the length of the push in seconds.

3. The average velocity of the pushes, calculated as by, e.g.:

$$\frac{{\sum }_{n = 1}^{N} {r}_{w} \frac{{\int }_{0}^{{t}_{p , n}} {ω}_{w , n} dt}{{t}_{p , n}}}{N}$$

4. The number of pushes, N

5. The seconds active, calculated as by, e.g.:

Σₙ₌₁^{N}r_{w}∫₀^{t}^{_{p,n}}H(a_{wc,n}−a_{th,n})dt

Where H(x) is the Heaviside step function, and aₜₕ is an adequately sized threshold acceleration.

6. The number of Redline events, calculated as by, e.g.:

Σₙ₌₁^{N}H[max(a_{wc,n})+a_{R}−RR·(a_max+a_{R,calib})]

Where RR is the redline ratio, aₘₐₓ is the per-user calibrated maximum push intensity, and a_{R,calib} is rolling resistance found when calibrating aₘₐₓ.

In one example, one or more of the above output parameters are continually calculated and recorded over a configurable recording period and become data accessible to the user. It should be noted that more complex algorithms have been developed and may be used to account for non-straight-line pushing. More complex algorithms may use two sensor systems 102, one to each of the rear wheels 204, and communication between them before uploading data to a remote computing device such as the mobile phone 104.

As illustrated above, in some embodiments, the rotational acceleration is estimated by differentiating the rotational velocity. However, in some situations, this has been found to be noisy. As an alternative technique, better results may be obtained by calculating the rotational acceleration by measuring the tangential acceleration. To estimate rotational acceleration according to tangential acceleration, the first and second accelerometers 120a, 120b are implemented as two biaxial accelerometers, each measuring the axial and tangential acceleration components.

As described above, in one example, Redliner application 132 may periodically communicate with the sensor system 102 using a proprietary Bluetooth protocol developed for Redliner application 132. The Redliner application 132 may include a data service component including a number of unread packets, most recent packet ID, desired packet to read, packet, and redline occurring components and setting service component including version, device name, time, error, redline percent, capacity collection mode, and battery level components.

Wheelchairs may include several different types of wheels thus the sensor system 102 may need to be mounted in different ways on each according to exemplary embodiments. A range of attachment options may be provided with sensor system 102, to accommodate the differences in wheelchair wheel design and dimensions. One example for attaching sensor system 102 to a wire spoke wheelchair wheel, (which is the style most widely used) is illustrated in FIG. 4. As illustrated in FIG. 4, one or more backing plates with guides 400 may be used to operably mount sensor system 102 to a wheelchair wheel 204. Examples of means for mounting the sensor system 102 to a wheel include clamps, guides rails, clips, ties, magnetic locks, friction fit, elastic loops, and cords. In some embodiments, the sensor system 102 is mounted to a wheel by the end user and the wheel is just a normal wheelchair wheel and does not need to have special manufacturing requirements. In some embodiments, the sensor system 102 is mounted to a corresponding wheel that has corresponding mounting hardware and/or a position suited for mounting on the wheel prepared in advance during the manufacturing process of the wheel.

Packaging may also be included on the sensor system 102 and/or wheel in order to protect the circuitry and sensor(s) 116 of the sensor system 102. For example, the sensor system 102 may be housed within a waterproof plastic package or may be mounted within a water-proof housing available on the wheel 204. In some embodiments, the sensor system 102 is both mountable to the wheel and removable from the wheel 204 by the end user thereby allowing the user to use a single sensor system 102 at different times on different vehicles.

Further implementation details of the sensor system 102 and Redliner application 132 and related testing examples are described in U.S. Provisional Patent Application No. 62/237,669 filed on Oct. 6, 2015 and PCT International Patent Application No. PCT/CA2016/051160 filed on Oct. 5, 2016, which are both entitled “SYSTEMS AND METHODS FOR MONITORING THE ACTIVITY OF WHEELCHAIR USERS” and which are both incorporated herein by reference.

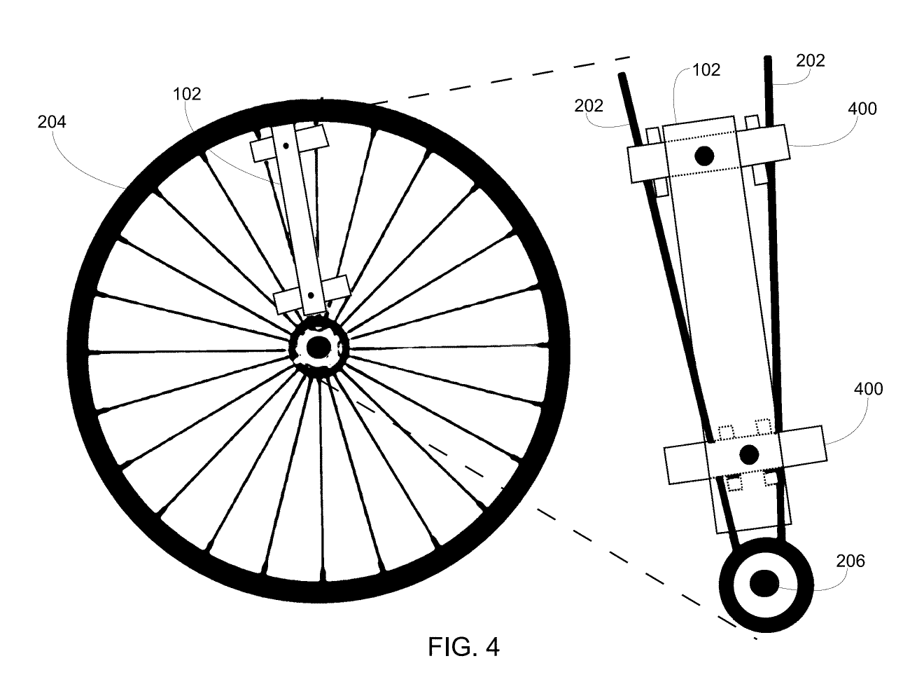

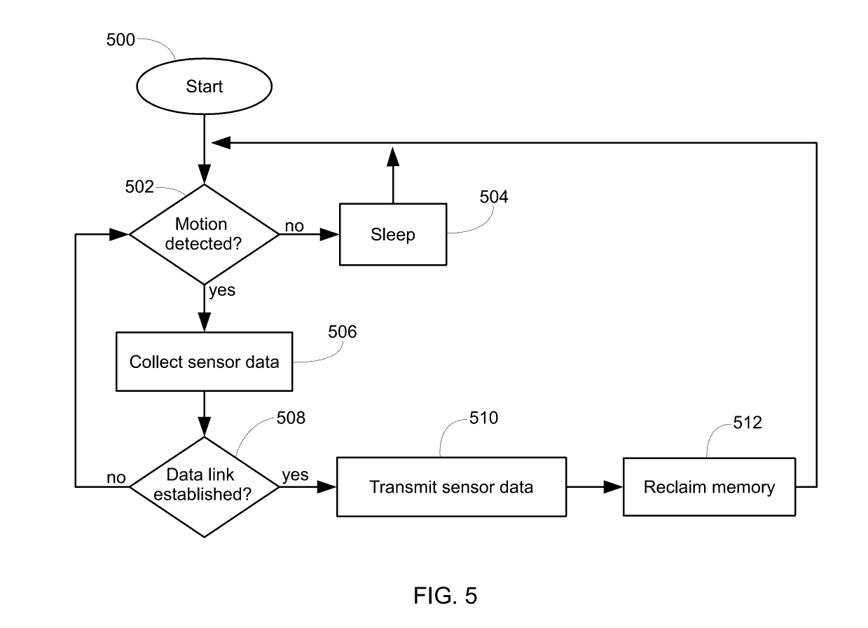

FIG. 5 shows a flowchart of operations performed by the sensor system 102 of FIG. 1 according to an exemplary embodiment. The steps of FIG. 5 are not restricted to the exact order shown, and, in other embodiments, shown steps may be omitted or other intermediate steps added. In this embodiment, the processor 124 of the computing device 300 executes the firmware 112 loaded from the storage device 110 in order to cause the sensor system 102 to perform the illustrated steps.

The process of FIG. 5 begins at step 500 upon power up of the sensor system 102. For instance, in some embodiments, the sensor system 102 is always on as long as battery power is supplied. The battery may be automatically charged as a result of motion of the wheel 204 so that the battery does not need to be replaced. Alternatively, the battery may be recharged or replaced as desired by the user such as by plugging in the sensor system 102 overnight or when not in use. In this example, as soon as the battery provides power to the sensor system 102, control proceeds to step 502.

At step 502, the sensor system 102 determines whether motion of the wheel 204 is detected. Motion may be detected, for example, by the processor 124 receiving updated sensor data from one of the onboard sensors 116 such as the accelerometer 120a, 120b detecting the spinning motion of the wheel 204. If no motion is currently detected, control proceeds to step 504; alternatively, control proceeds to step 506.

At step 504, the sensor system 102 enters a sleep mode by powering down unused components to conserve batter power. In an exemplary embodiment, sleep mode involves powering down all components except for the real time clock 128 and a power interrupt monitoring circuit of the processor 124. The clock 128 will wait a predetermined time period such as five minutes and then power of the sensor system 102 by asserting a signal inputted to the power interrupt circuit of the processor 124. The process will then return to step 502 to check for motion. In another embodiment, the sleep mode involves power down all components except for one of the sensors 116 and a power interrupt monitory circuit of the processor 124. Upon detecting motion, the powered up sensor will trigger power up of the sensor system 102 by asserting a signal inputted to the power interrupt circuit of the processor 124. Control then returns to step 502.

At step 506, the sensor system 102 collects sensor data 114. For example, the processor 124 receives information from the sensors 116 concerning motion of the wheel 204 and stores corresponding sensor data 114 in the storage device 110.

At step 508, the sensor system 102 checks whether a link has been established to an remote computing device. For example, the processor 124 will check whether the Bluetooth interface 126 has paired with the Bluetooth interface 146 of a remote computing device such as the user's mobile phone 104. In situations where the mobile phone 104 is not within range of the sensor system 102, there will be no connection available and control will return to step 502 to again check whether there is motion and to continue collecting sensor data 114 if yes. On the other hand, if there is currently a data link established with a remote device such as the mobile phone 104, control proceeds to step 510.

At step 510, the sensor system 102 transmits the sensor data 114 to the remote device via the data link established at step 508. In an example, the processor 124 retrieves the sensor data 114 from the storage device and wirelessly transmits it to the mobile phone 104.

At step 512, the sensor system 102 reclaims memory by deleting the portion of the sensor data 114 that was successfully transmitted to the remote computing device at step 510. In this way, once a particular section of the sensor data 114 is passed onward to the user's mobile phone 104 (or other computer device), this particular section of the data 114 is deleted from the storage device 110 within the sensor system 102 thereby enabling new sensor data 114 to be collected and stored in the newly freed memory area. In one embodiment, the sensor system 102 may have a storage device 110 with capacity sufficient to store a predetermined number of hours (e.g., twelve hours) of sensor data 114 before needing to transmit said data 114 to a remote computing device in order to free up memory to store more data. After reclaiming the memory area, the process returns to step 502 to check whether there is still motion.

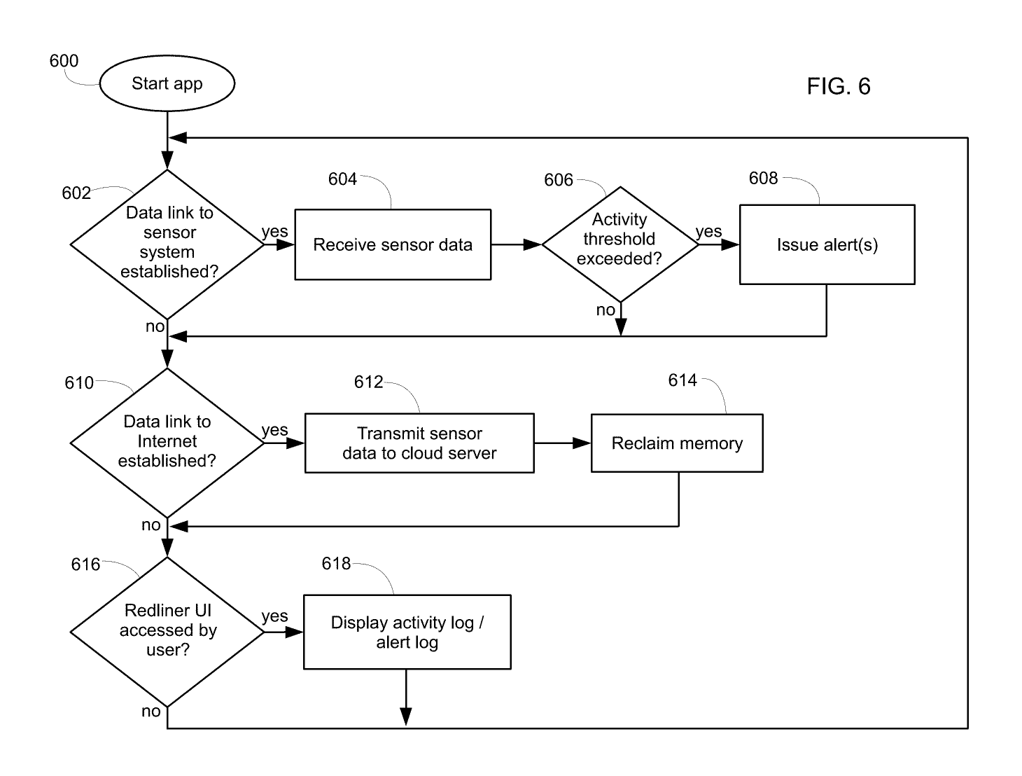

FIG. 6 shows a flowchart of operations performed by the mobile phone 104 of FIG. 1 according to an exemplary embodiment. The steps of FIG. 6 are not restricted to the exact order shown, and, in other embodiments, shown steps may be omitted or other intermediate steps added. In this embodiment, the processors 144 of the mobile phone 104 execute the Redliner application 132 loaded from the storage device 110 in order to cause the sensor system 102 to perform the illustrated steps.

The process of FIG. 6 begins at step 600 upon the mobile phone 104 executing the Redliner application 132. In some embodiments, the Redliner application 132 keeps at least a part of the application 132 running on the mobile phone 132 at all times in order to be able to receive sensor data 114 from the sensor system 102 at any time. In this way, as the user carries the mobile phone 104 on their person, the mobile phone 104 will at any time be able to receive updated sensor data 114. However, continual running of the Redliner application 132 is not a requirement. In other embodiments, the process of FIG. 6 may only be performed in response to the user manually starting the Redliner application 132; once the application 132 is closed, the process of FIG. 6 is terminated.

At step 602, the mobile phone 132 checks whether it has established a data link with the sensor system 102. Step 602 corresponds to step 508 of FIG. 5 but from the mobile phone 104's point of view. For instance, the data link may be a Bluetooth connection between the Bluetooth interfaces in the sensor system 102 and the mobile phone 104. When a data link is established, control proceeds to step 604; otherwise, control proceeds to step 610.

At step 604, the mobile phone 104 receives the sensor data 114 from the sensor system 102 over the data link established at step 602. This step corresponds to step 510 of FIG. 5 but from the point of view of the mobile phone 104. After receiving sensor data 114, the mobile phone 104 stores corresponding sensor data 134 in the storage device 130. The sensor data 134 stored at the mobile phone 104 may be the same as the sensor data 114 received from the sensor system 102. However, in some cases the sensor data 134 stored at the mobile phone 104 may be different than the sensor data 114 received from the sensor system 102 because the mobile phone 104 may process the data such as be performing one or more of the various algorithms to convert the raw data to wheel motion values such as activity level or purposive force or percentage of a red-line threshold etc.

It may also be the case that the mobile phone 104 stores additional sensor data 134 that was never received from the sensor system 102. For example, in some embodiments, the sensor system 102 may not include the GPS receiver 118; however, the sensor system 102 will tag all sensor data 114 with a time stamp taken according to the clock 128 and pass the time-tagged sensor data 114 to the mobile phone 104. The mobile phone 104 is configured to keep a local tracking log showing the GPS location of the mobile phone 104 at all times according to its onboard GPS 138 and clock 148. Assuming the user keeps their mobile phone on their person while operating the wheelchair 200, after receiving time-tagged sensor data 114 from the sensor system 102, the mobile phone can then determine the approximate location of the wheelchair be correlating the position of the mobile phone 104 for each time-tagged data point in the received sensor data 114.

At step 606, the mobile phone 104 determines whether one or more activity levels indicated by the sensor data 134 have exceeded a Redliner threshold level. For example, if the activity level of the user as indicated by the sensor data 134 has reached eighty-percent of the user's maximum activity levels, control will proceed to step 608. The threshold may be adjusted to any desired level in other embodiments.

At step 608, the mobile phone 104 issues one or more redline alerts to the user such as by vibrating, tones, and/or sending electronic messages to other devices like a Bluetooth enabled wristwatch or other wearable device to alert the user to reduce activity levels a bit.

At step 610, the mobile phone 104 determines whether a data link is available with the Internet 108. For instance, this may be done by the processors 144 of the mobile phone checking the network interface 152 to look for a WiFi or other wireless local area network (WLAN) connection with an access point 154 or cell service provider base station. If no network connection is established at this time, control returns to step 602 to continue collecting data both using any onboard sensors 136 and/or from the sensor system 102. Alternatively, if a network connection to the Internet 108 is available, control proceeds to step 612.

At step 612, the mobile phone 104 transmits the sensor data 134 to the monitoring server via the network interface 152 and the Internet 108.

At step 614, the mobile phone 104 reclaims memory by deleting the portion of the sensor data 134 that was successfully transmitted to the monitoring server 106 at step 612. In this way, once a particular section of the sensor data 134 is passed onward to the user's account on the monitoring server 106, this particular section of the data 134 is deleted from the storage device 130. Alternatively, step 614 may be omitted if the user prefers to keep the sensor data 134 on the mobile phone 104 even after transmitting said data to the cloud-based monitoring server 106. Whether or not to delete the transmitted sensor data 134 may be a user configurable option.

At step 616, the mobile phone 104 determines whether the user has access a UI screen of the Redliner application 132 in order to view a graphical or other representation of the sensor data 134. When yes, control proceeds to step 618.

At step 618, the mobile phone 104 displays the Redliner UI screen. The user may then view and work with the sensor data 134 stored on the mobile phone and/or view and work with the user's cloud based account on the monitoring server 106 via the Redliner application 132. Alerts and or wheelchair setting change message may also be displayed within the Redliner UI screen at step 618.

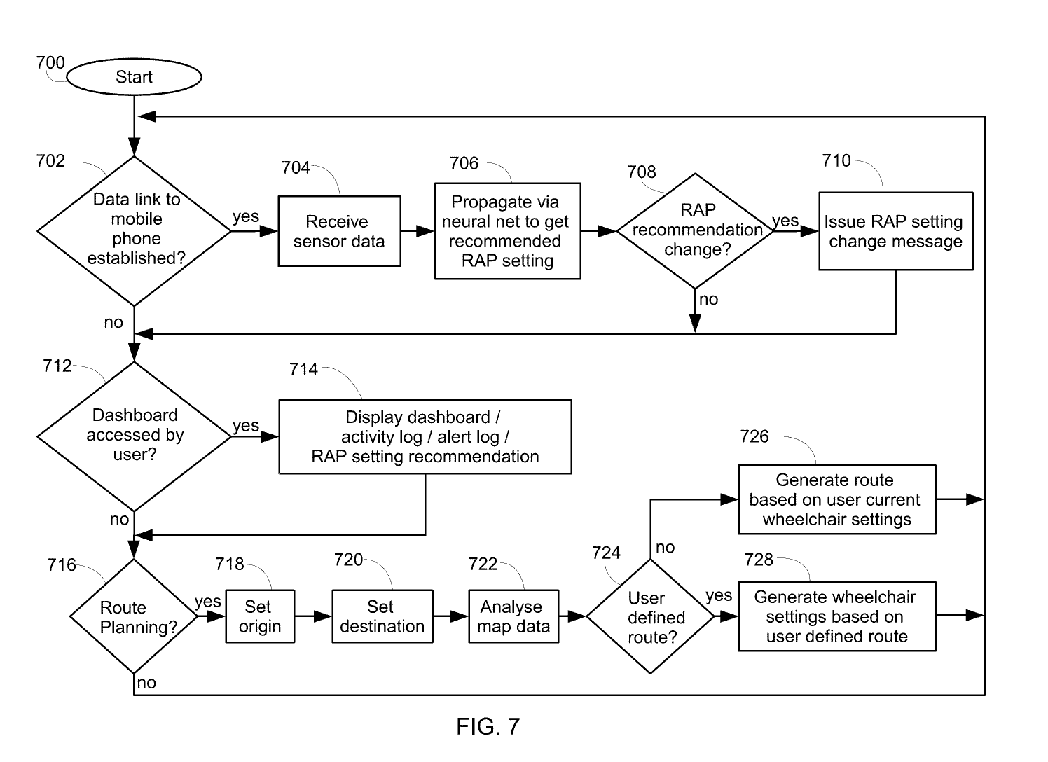

FIG. 7 shows a flowchart of operations performed by the monitoring server 106 of FIG. 1 according to an exemplary embodiment. The steps of FIG. 7 are not restricted to the exact order shown, and, in other embodiments, shown steps may be omitted or other intermediate steps added. In this embodiment, the processors 166 of the monitoring server 106 execute the webserver application 158 and/or the neural network 160 loaded from the storage device 156 in order to cause the monitoring server 106 to perform the illustrated steps.

The process of FIG. 7 begins at step 700 upon the monitoring server booting up and executing the webserver application 158.

At step 702, the monitoring server 106 checks whether it has established a data link with the mobile phone 104. Step 702 corresponds to step 610 of FIG. 6 but from the point of view of the monitoring server 106. When a data link is established, control proceeds to step 704; otherwise, control proceeds to step 712.

At step 704, the monitoring server 106 receives the sensor data 134 from the mobile phone 104 over the data link established at step 702. This step corresponds to step 612 of FIG. 6 but from the point of view of the monitoring server 106. After receiving the sensor data 134, the monitoring server 106 stores the sensor data 134 in a user account with which the sensor data 134 is associated. In some embodiments, the Redliner application 132 stores a user identifier and/or other credentials such as username and password. The user identifier is sent from the mobile phone along with the sensor data 134 and the monitoring server utilizes the received user identifier in order to identify with which user account the newly received sensor data 134 is associated.

At step 706, monitoring server 106 propagates the sensor data 134 (possibly along with other user data) via a neural network 160 in order to determine a recommended rear axle position (RAP) setting for the user's wheelchair 200.

Generally speaking, there are two competing factors that are affected by RAP setting that are indirectly related: wheelchair stability and propulsion efficiency. The optimum RAP is where the maximum propulsion efficiency is achieved without compromising the needed wheelchair stability for the wheelchair user.

On the other hand, for every wheelchair 200, in additional to seat-to-wheel distance, there are quite a few factors that affect the wheelchair stability and efficiency. This makes is somewhat complicated to find a good RAP which gives a high propulsion efficiency along with providing the necessary wheelchair stability.

The following lists provides examples of many reasonable factors that could affect RAP position and that may be taken into account by the neural network 160 when generating a recommend RAP position setting at step 708.

Variables that the wheelchair user and/or the clinician may fill in personally include: body shape, age, level of injury, trunk control, whether or not using an anti-tipping bar on the wheelchair, degree of comfort of the wheelchair user, wheelchair user's weight, wheelchair user's preference, chances of encountering curbs or other obstacles during the wheelchair usage, shoulder push start angle, and whether or not the user is leaning back at push start.

Variables that may be obtained from a wheelchair activity monitor such as the sensor system 102 and/or mobile phone 104 illustrated in FIG. 1: sophistication of the wheelchair user, chances of encountering ramps or other obstacles during wheelchair usage, activity level, tipping occasions, stroke length, and wheelchair user's pushing experience. Each of these factors will be automatically updated by the monitoring server 104 over time for each user, using the wheelchair activity monitor's sensor data 114, 134.

Although any combination and permutation of these factors can be taken into account by the neural network 160 at step 706, in the following, ten exemplary factors are utilized for illustration purposes.
1. trunk control,
2. whether or not using an anti-tipping bar on the wheelchair,
3. wheelchair user's preference,
4. shoulder push start angle,
5. whether or not leaning back at push start,
6. sophistication of the wheelchair user,
7. chances of encountering ramps during the day,
8. activity level,
9. tipping occasions, and
10. wheelchair user's pushing experience

The above ten factors were chosen based on their relative importance; however other factors may be chosen for the neural network 160 to consider in other implementations as desired—see table 1 below for definitions of how these factors are defined and represented in numerical format.

TABLE 1
Variables taken into account in the neural network algorithm and their range

| | | | | | |
|---|---|---|---|---|---|
| Output | RAP (Rear Axle Position) | Back | Middle | Front | 1: B 2: M 3: F |
| Inputs | Wheelchair pushing | low (under | medium (.5 to | high (more | 1: L 2: M 3: H |
| | experience | 6 months) | 2 years) | than two | |
| | | | | years) | |
| | Tipping Occasions | low | medium | high | 1: L 2: M 3: H |
| | Activity Level | low | medium | high | 1: L 2: M 3: H |
| | Ramps | few | several | Many | 1: F 2: S 3: M |
| | Sophistication of Wheelchair | low | medium | high | 1: L 2: M 3: H |
| | user | | | | |
| | Preference | stable | more | | 1: STBL 2: MNV |
| | | | maneuverable | | |
| | Leaning back at push start | yes | no | | 1: Y 2: N |
| | Shoulder Push start angle | >20 deg | 10<<20 deg | <10 | 1: >20 2: 10<<2 |
| | | | | | 3: <10 |
| | anti-tipping | Yes | No | | 1: Y 2: N |
| | Trunk control | low | good | high | L: 1 G: 2 H: 3 |

| | |
|---|---|
| Range of Variables | Value assigned for |
| | each range |

When dealing with a large number of variables in a problem, one good way to solve the problem is using a neural network 160. The neural network 160 can be described as an algorithm that learns from some real experimental data and predicts the outcome for new sets of data for input variables. Thus, in order to make a neural network 160 capable of solving the problem of determining the recommended RAP setting, training data is first needed. The training data may be obtained through experiments performed using different combinations of the above factors and known recommended RAP settings for each combination. As each neural network 160 may also be designed to provide recommendations for a specific wheelchair model 200, obtaining training data for a new model will involve designing and undertaking adequate experiments for the particular chair 200. However, for helping to illustrate the concept herein, the inventors have created some simulated data similar to what real data should look like for a particular wheelchair 200. Using the simulated training data, a neural network 160 was trained. The inventors then created and used the trained algorithm to see what was the recommended RAP setting for new combinations of factors different than the training data. Since ten different input factors were chosen for the exemplary neural network 160 described herein, at least ten sets of training data were required. To provide for some extra training samples, fourteen combinations of training data were utilized below—see table 2.

TABLE 2
Fourteen sets of training data used to train the neural network 160 algorithm, and one set of test
data showing the recommend RAP setting output by the neural network 160

| | Training | 1 | 2 | 3 | 4 | 5 | 6 | 7 | 8 | 9 | 10 | 11 | 12 | 13 | 14 | Test |
|---|---|---|---|---|---|---|---|---|---|---|---|---|---|---|---|---|
| Inputs | Trunk control | 2 | 2 | 2 | 2 | 3 | 3 | 1 | 1 | 3 | 3 | 3 | 3 | 1 | 1 | 1 |
| | anti-tipping | 2 | 2 | 2 | 2 | 2 | 2 | 1 | 1 | 1 | 1 | 2 | 2 | 2 | 1 | 1 |
| | Shoulder push start angle | 1 | 1 | 1 | 1 | 1 | 1 | 3 | 2 | 2 | 2 | 2 | 1 | 3 | 3 | 1 |
| | Leaning back at push start | 1 | 1 | 1 | 1 | 1 | 1 | 2 | 2 | 2 | 2 | 2 | 1 | 2 | 2 | 1 |
| | Preference | 1 | 1 | 1 | 1 | 2 | 2 | 1 | 2 | 2 | 2 | 2 | 1 | 1 | 2 | 1 |
| | Sophistication of wheelchair | 1 | 2 | 3 | 3 | 1 | 2 | 3 | 2 | 1 | 2 | 1 | 1 | 2 | 3 | 1 |
| | user | | | | | | | | | | | | | | | |
| | Ramps | 1 | 1 | 1 | 1 | 2 | 2 | 3 | 3 | 3 | 2 | 3 | 3 | 3 | 1 | 1 |
| | Activity Level | 1 | 1 | 1 | 1 | 3 | 3 | 2 | 2 | 2 | 3 | 2 | 1 | 2 | 3 | 1 |
| | Tipping Occasions | 1 | 1 | 2 | 3 | 1 | 1 | 1 | 2 | 3 | 2 | 3 | 3 | 1 | 1 | 1 |
| | Wheelchair pushing | 1 | 2 | 3 | 3 | 1 | 1 | 3 | 2 | 2 | 2 | 2 | 1 | 2 | 3 | 1 |
| | experience | | | | | | | | | | | | | | | |
| Output | RAP (Rear Axle Position) | 2 | 2 | 2 | 1 | 2 | 3 | 3 | 2 | 2 | 3 | 1 | 1 | 2 | 3 | 2 |

The neural network code was created in MATLAB (See Appendix A) and was run until an error of <10 e-7 was obtain along with a performance >70%. The obtained neural network weights and bias data was saved to Matlab.mat, and the weights and bias data is provided below as Appendix B for reference.

As will be understood by persons familiar with the MATLAB software tool, m-files are the files utilized for writing and running codes. mat-files, on the other hand, are used to store the results (variable magnitudes) of a program that has been run. Neural network problems are iterative in nature and should be solved using numerical methods (similar to trial and error). For a person to recreate the neural network for testing, the “Attachment A” file should be run using this method until getting to a point of acceptable error and performance. Then the results should be saved to a file such as a “matlab.mat” file. Thereafter, if anyone wants to use the neural network, the person may open the “Attachment B” and, if desired, replace their own data, and also open the “matlab.mat” to load the variables and then run the “Attachment B” to see the results for Rear Axle Position. The Attachment A may be re-run at any time to find the variables by running it until an acceptable performance and error is achieved. The variable magnitudes could be slightly different, but correct in “numerical analysis”.

In summary, using the above simulated data set, a neural network 160 was created that could recommend a RAP setting for any new data set given the ten input factors indicated above in table 1. When running the neural network code using the code provided below in the Appendix B and also using Matlab.mat one will see the results for RAP as ‘farthest back’, ‘middle’, or ‘farthest forward’. These respectively correspond to RAP settings P1, P3, and P5 shown above in FIG. 2.

Of course, the above process is the process utilized for testing/development and is described to help illustrate the neural network operation and creation. In preferred embodiments, the dashboard-based neural network 160 has the variable magnitudes built-in and none of the above MATLAB steps would need to be done by the end user.

Although only three RAP positions were utilized in this neural network, this was to help simplify the simulated example. The neural network 160 utilized for a production environment may of course be designed to recommend one of five (or any number) or RAP settings and may take into account any number of input factors other ten, and each factor may have possible values defined as desired according to application requirements.

Returning to the description of FIG. 7, after the sensor data 134 received from the mobile phone 104 and any other desired input factors have been run through the neural network 160 at step 706, control proceeds to step 708.

At step 708, the monitoring server compares the recommended RAP setting generated by the neural network 160 at step 706 with the user's current RAP setting as stored in the user data 162. If the two match, this means the user is current RAP setting is already the recommended RAP setting. In this case, control proceeds to step 712. However, if the recommended RAP setting generated at step 706 does not match the user's current RAP setting, this means that a change is required so control proceeds to step 710.

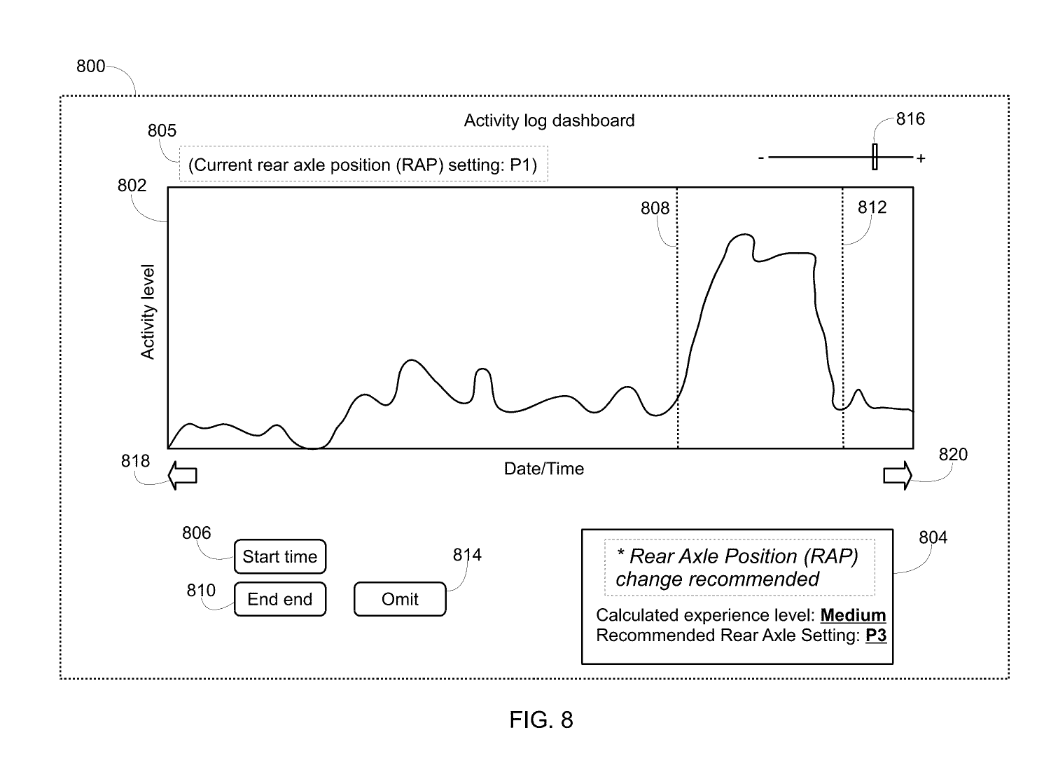

At step 710, the monitoring server issues one or more RAP setting change message(s). A RAP setting change message may be transmitted via the network interface 168 in the form of an email alert or other push notification sent to the user's mobile phone 104. Alternatively, the setting change message be transmitted via the network interface 168 in the form of a webpage that is retrieved by the user such as that illustrated in FIG. 8. Any desired application-specific or proprietary protocol may also be utilized to send change messages such as when utilized to effect automated RAP setting changes on the user's wheelchair 200. Combinations of the push/pull setting change messages may be used such as sending the user a push notification to log in to their account on the monitoring server 106 in order to view the setting change message issued at step 710. Assuming the user accepts the recommend RAP setting, the user will change their current RAP setting to match the recommended RAP setting. The new current setting will then be passed to the monitoring server 106 for storage in the user data 162.

Likewise, besides sending the setting change message(s) to the user directly, one or more setting change messages may also be issued at step 710 to a clinician who is assisting the end user with wheelchair configurations. The clinician may have permission from the user to access the user data 162 on the monitoring server 106, and the monitoring server 106 may notify both the user and their clinician of a newly recommended RAP setting.

At step 712, the monitoring server checks whether the user and/or the clinician is accessing the web-based dashboard. The webserver application 158 may determine that a user is logging in and confirm the login credentials such as username/password are correct and match a valid user. When yes, control proceeds to step 714.

At step 714, the webserver application 158 running on the monitoring server 106 generates a webpage dashboard providing statistics and other details to the user concerning the user's wheelchair activity, sensor data 114, 134, Redliner alerts log, RAP setting change messages, etc. An example of a screen provided by the webserver application 158 at step 714 is shown in FIG. 8.

At step 716, the monitoring server 106 determines whether the user has made a route planning request. Route planning requests in this embodiment may be received either directly from the user at the web-based dashboard or via the user accessing a route planning function within the Redliner application 132 running on the mobile phone 104. When a route planning request is received, control proceeds to step 718; alternatively, control returns to step 702 to repeat the above-described process.

At step 718, the monitoring server 104 sets the origin position. In some embodiments, there are two types of route planning requests available to the user: a request for a recommended route, or a request with a predetermined route. When the user is requesting a recommended route, the user will provide a starting point, i.e., the origin set at step 718. For instance, the origin may be chosen by the user moving an origin marker on an interactive map displayed on touchscreen 150 or by inputting an address of the point of origin using touchscreen 150. Alternatively, when the user is making a route planning request with a predetermined route already defined, the origin is already known because the desired route is predefined.

At step 720, the monitoring server sets the destination position. Again, when the user is requesting a recommended route, the user will provide the ending point, i.e., the destination position at step 720. For instance, the destination may be chosen by the user moving a destination market on the interactive map. Alternatively, when the user is making a route planning request with a predetermined route already defined, the destination is already known because the desired route is predefined.

At step 722, the monitoring server 106 analyses the map data 164 stored in the storage device 156 according the origin, destination, and/or predetermined route. The map data 164 contains geomatics data related to the terrain, paths, roads, sidewalks, wheelchair ramps including length of ramps and grade of ramps, and any elements that may be obstacles to a wheelchair traversing from the origin to the destination.

At step 724, the monitoring server 106 determines whether there is a predetermined route already provided by the user. When yes, control proceeds to step 726; alternatively, control proceeds to step 728.

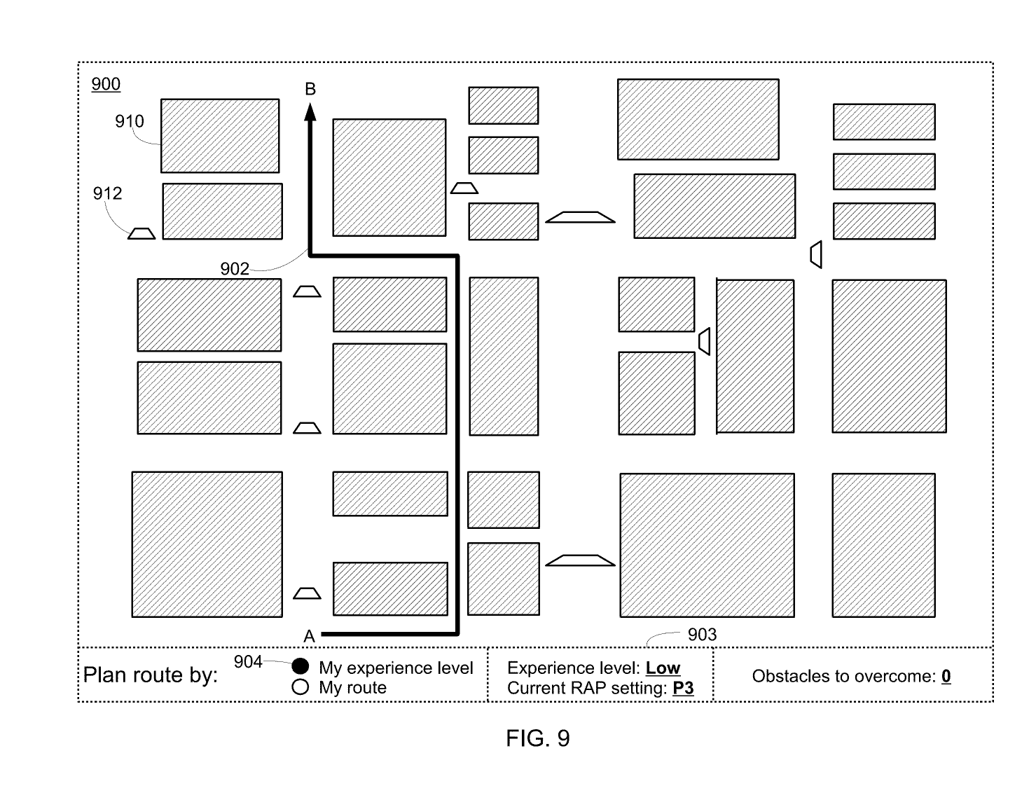

At step 726, because there is no predetermined route, the monitoring server 106 generates a plurality of possible routes by performing a pathfinding and/or route planning algorithm. For each possible route from the origin to the destination, the monitoring server 106 tracks the number and intensity of obstacles 210 such as curbs, steps, difficult terrains such as grass, etc. that may be encountered on that route. The monitoring server 106 then chooses a particular path that is compliant with the wheelchair user's current RAP setting. For instance, if the user sensor data 114, 134 causes the neural network to recommend a RAP setting of P3, this recommendation will be sent to the user. The monitoring server 104 will then provide the user with the shortest available route from origin to the requested destination where no obstacles will be encountered that would exceed the user's current/recommended RAP setting of P3. See FIG. 9 described in further detail below for an example of a recommended route planned according to the user's current RAP setting.

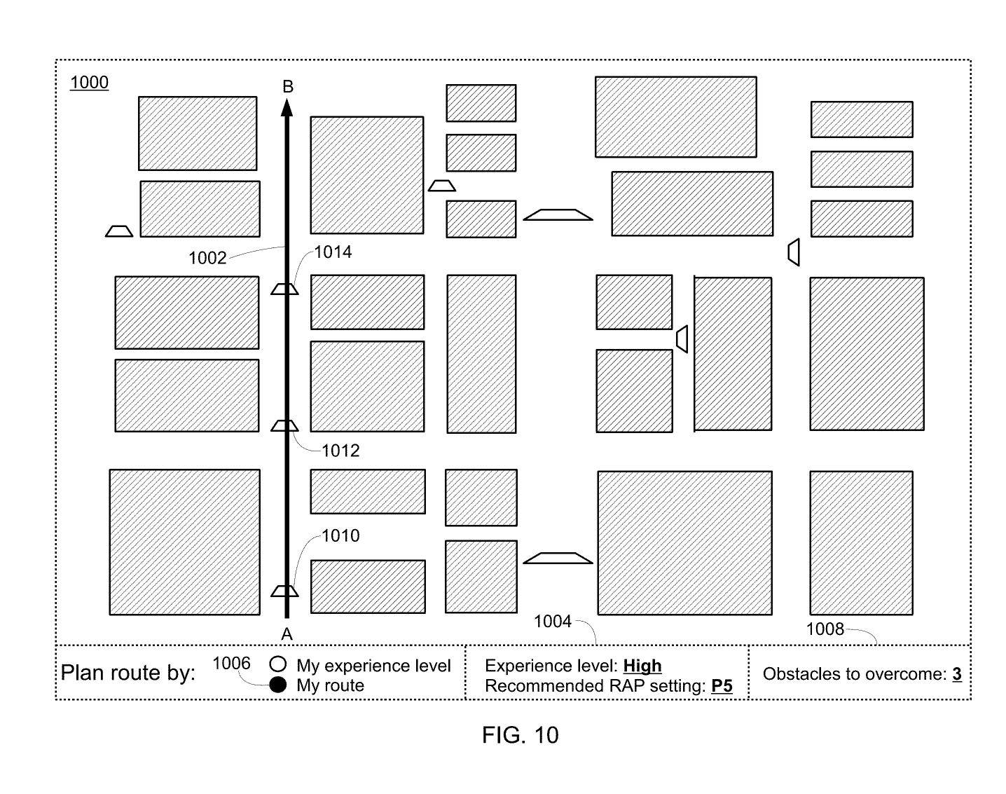

At step 728, because there is a predetermined route already provided by the user, the monitoring server 106 checks the predetermined route to see which obstacles will be encountered if the user proceeds to traverse that route. By looking for the greatest obstacles with the highest difficulty level, the monitoring server 106 can determine a required RAP setting in order to traverse the route. The monitoring server 106 then compares the required RAP setting for the predetermined route with the user's current RAP setting. If the required RAP setting is greater than the user's current RAP setting, this means the predetermined route has a difficulty level that exceeds the user's current RAP setting. For instance, perhaps there are curbs or other obstacles on that route will require the user to pop the front wheels 210 up higher than the current RAP setting will allow. In response, the monitoring server 106 issues a warning of this fact to the user so that the user's is aware that the route is more difficult than the current RAP setting. See FIG. 10 described in further detail below for an example of recommended RAP setting warning for a predetermined route that is more difficult than the user's current RAP setting.

FIG. 8 illustrates a web-based dashboard user interface (UI) screen 800 generated by the webserver of FIG. 1 providing a graph 802 of a user's activity levels and a recommend rear axle position (RAP) setting 804 according to an exemplary embodiment. In other embodiments, the dashboard UI screen 800 may instead or in addition be generated and displayed by the Redliner application 132 running on the user's phone 104 or on the user's home computer 170. The recommended RAP setting 804 is determined by the neural network 160 according to the various factors described above. The graph 802 is calculated based on the activity level algorithm described above. Both the RAP setting 804 and the graph 802 are based at least in part of the sensor data 114, 134 reflecting movement of the wheelchair 200 over time.

As illustrated, the recommended RAP setting 804 may differ from the user's current RAP setting 805. If the user accepts the recommended RAP setting 804 and makes the change to the rear axle 216 on the wheelchair 200, the current RAP setting 805 will be updated to match the recommended RAP setting 804. This update may occur either by the user manually updating the current RAP setting 805 by logging in to the monitoring server 106 and updating a field such as a changing a radio button selection to position P3. Alternatively, the sensor data 114, 134 may include the current RAP setting within the data as determined by a RAP sensor 117 installed on the wheelchair 200.

Because some of the sensor data 114, 134 may be known by the user to be unsuitable for calculating the recommended RAP setting 804, the UI screen 800 includes a mechanism to omit any portion(s) of the graph 802 from said calculation. In particular, a first button 806 allowing the user to set a start time line 808 within the graph representing the starting time of a section to ignore. The start timeline 808 can be moved to any desired position by the user clicking and/or dragging the line 808 utilizing the touchscreen 150 on their mobile phone 104, for example. A mouse connected to the user home computer 170 could be utilized in another example. A second button 810 allows the user to set an end time line 812 of the section to ignore, and again the end time line 812 can be positioned at any location in the graph 802 by the user.

Once the start and end time lines 808, 812 are in the correct positions to mark a portion of the activity graph 802, the user can click the omit button 814 in order to prevent the neural network 160 from utilizing the marked portion of the sensor data 114, 134 when calculating the recommended RAP setting 804. The user may repeat the above process to mark any number of separate sections of the graph 802 as invalid data. This may be useful for example if the user loaned their wheelchair to another user for a period of time and therefore the marked sections are sensor data 114, 134 collected when another person was utilizing the chair 200 and therefore do not reflect the user's actual activity. Likewise, a user may have been using the chair deliberately in a non-ideal fashion perhaps with the assistance of another person during a period of time and does not want to be recommended an inappropriate RAP setting based on the neural network 160 assuming the non-ideal usage was intended as normal by the user.

Graph viewing controls are provided on the dashboard UI screen 804 illustrated in FIG. 8 including a zoom level control 816 and left and right scroll arrows 818, 820. By interacting with these controls 816, 818, 820 the user may view any desired section of the graph 802 and may view the history of activity levels stored in the user's data 162 stored on the monitoring server 106.

FIG. 9 shows a first route planning UI screen 900 providing the user with a recommended route 902 that is compatible in difficulty level with the user's current RAP setting 903 according to an exemplary embodiment. The UI screen 900 of FIG. 9 may be generated by the webserver application 158 while performing step 726 of FIG. 7. As shown, the user has selected a first radio button 904 instructing the monitoring server 104 to perform the route planning based on the user's experience level. In this embodiment, the user's experience level is directly tied to the user's current RAP setting 903. The user has selected an origin A and a destination B on the map and a route planning algorithm of running on the monitoring server 104 has displayed a recommended route 902 that avoids both the impassible areas 910 and all obstacles 912 that exceed the user's current RAP setting 903 and associated experience level. In the underlying map data 164, each of the obstacles 912 may have an associated required RAP setting and/or experience level. The monitoring server 106 searches for the recommended route 902 that avoids obstacles 912 needing to be traversed by the wheelchair 200 that would exceed the difficulty level of the current wheelchair setting 903.

FIG. 10 shows a second route planning UI screen 1000 warning the user that a predetermined route 1002 involves changing to a recommended RAP setting 1004 higher than the user's current RAP setting 1008 according to an exemplary embodiment. Like the UI screen 900 of FIG. 9, the UI screen 1000 of FIG. 10 may also be generated by the webserver application 158, although this time while performing step 728 of FIG. 7. In this case, the user has selected a second radio button 1006 instructing the monitoring server 104 to perform the route planning utilizing the user's predetermined route 1002. The user's predetermined route 1002 may be input by the user dragging their finger along the map utilizing the touchscreen 150 on the mobile phone 104, for example. The monitoring server 104 then analyses the map data 166 according to the predetermined route 1002 in order to determine a required wheelchair setting. This may be done by the monitoring server 104 determining one or more obstacle 1010, 1012, 1014 with a greatest difficulty level needing to be traversed by the wheelchair 200 in order to travel along the predetermined route 1002. The most difficult obstacle 1010, 1012, 1014 directly equates to the required RAP setting. The monitoring server 106 then compares the required RAP setting with the current RAP setting 805. When the required RAP setting exceeds a difficulty level of the current RAP setting, the monitoring server 106 transmits a route planning message via the communication interface with a warning to switch to a higher recommended RAP setting 1004. As an additional reference, the number of obstacles 1010, 1012, 1014 needing to be traversed along the predetermined route 1002 is display in an obstacle information section 1008 of the UI screen 1000.

Although the invention has been described in connection with preferred embodiments, it should be understood that various modifications, additions and alterations may be made to the invention by one skilled in the art without departing from the spirit and scope of the invention. For example, although the above examples have focused on the sensor system 102 passing sensor data 114 to a mobile phone 104 that then relays related sensor data 134 to a web based monitoring server 106, in other embodiments, the sensor system 102 may directly transmit the sensor data 114 to the monitoring server 106 utilizing a network interface (not shown) such as a WiFi chip integrated within the sensor system 102. In yet other embodiments, the above-described functionality of the monitoring server may be performed by the user's mobile phone 104 rather than a cloud-based monitoring server 106. In some embodiments, the user's mobile phone 104 can act as the portable activity monitor instead of or in addition to the sensor system 102. Likewise, the user's home computer 170 may run its own Redliner application 132 and perform the above-described functions of the mobile phone 104.

In another example modification, although the above description and examples have focused on the system 100 recommending rear axle position (RAP) settings, other wheelchair settings can also be recommended in similar manners. Examples of wheelchair settings that may be recommended include rear axle position (RAP), forward axle position (FAP), arm rest level, speed control and/or limits for electric wheelchairs, wheelchair type, wheelchair size, seat angle, seat level, anti-tipping bar position, etc. Additional sensors 116 may be included to monitor the current setting for any these adjustable settings.

Furthermore, although the above examples have focused on adjusting wheelchair settings, in other applications similar techniques can be utilized to adjust similar settings on other types of vehicles.

The mobile phone 104 illustrated in FIG. 1 is an example of a computing device that may be configured to transmit data to and receive data from the sensor system 102 and execute one or more applications (e.g., Redliner application 132) loaded from a memory 130, for example. Other examples of possible computing devices may include or be part of a portable computing device (e.g., a mobile phone, netbook, laptop, personal data assistant (PDA), or tablet device) or a stationary computer (e.g., a desktop computer, or set-top box), or may be another computing device. In each case, the computing device may include processor(s), memory, input device(s), output device(s), network interfaces, and wireless transceivers. Each of processor(s), memory, input device(s), output device(s), network interface, and wireless transceiver may be interconnected (physically, communicatively, and/or operatively) for inter-component communications. Operating systems, applications, and the Redliner application 132 may be executable by the computing device. It should be noted that although each of the sensor system 102, the mobile phone 104 and the monitory server 106 is illustrated in FIG. 1 as having distinct functional blocks, such an illustration is for descriptive purposes and does not limit these devices 102, 104, 106 to a particular hardware architecture. Functions of these devices 102, 104, 106 may be realized using any combination of hardware, firmware, and/or software implementations.

Processor(s) 124, 144, 166 may be configured to implement functionality and/or process instructions for execution in computing device. The processor(s) may be capable of retrieving and processing instructions, code, and/or data structures for implementing one or more of the techniques described herein. Instructions may be stored on a computer-readable medium, such as memory or other storage devices. Processor(s) may be digital signal processors (DSPs), general purpose microprocessors, application specific integrated circuits (ASICs), field programmable logic arrays (FPGAs), or other equivalent integrated or discrete logic circuitry.

Memory may be configured to store information that may be used by computing device during operation. Memory may be described as a non-transitory or tangible computer-readable storage medium. In some examples, memory may provide temporary memory and/or long-term storage. In some examples, memory or portion thereof may be described as volatile memory, i.e., in some cases, memory may not maintain stored contents when computing device is powered down. Examples of volatile memories include random access memories (RAM), dynamic random access memories (DRAM), and static random access memories (SRAM). Memory may be internal or external memory and in some examples may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) such as touch screen 150 may be configured to receive input from a user operating a computing device. Input from a user may be generated as part of a user running one or more software applications, such as Redliner application 132. Input device(s) may include a touch-sensitive screen, track pad, track point, mouse, a keyboard, a microphone, video camera, or any other type of device configured to receive input from a user.

Output device(s) may be configured to provide output to a user operating computing device. Output may include tactile, audio, or visual output generated as part of a user running one or more software applications, such as Redliner application 132. Output device(s) may include a touch-sensitive screen, sound card, a video graphics adapter card, or any other type of device for converting a signal into an appropriate form understandable to humans or machines. Additional examples of an output device(s) 308 may include a speaker, a cathode ray tube (CRT) monitor, a liquid crystal display (LCD), or any other type of device that can provide output to a user. In the example where computing device is a mobile device, output device(s) may be an LCD or organic light emitting diode (OLED) display configured to receive user touch inputs, such as, for example, taps, drags, and pinches.

Network and communications interfaces may be configured to enable computing device to communicate with external devices via one or more networks. Network interface may be a network interface card, such as an Ethernet card, an optical transceiver, a radio frequency transceiver, Bluetooth, or any other type of device that can send and receive information. Network interface may be configured to operate according to one or more of the communication protocols. Wireless transceiver may be a wireless transceiver configured to send and receive data. In one example, wireless transceiver and network interface may be integrated.

Operating systems may be configured to facilitate the interaction of applications, such as the webserver application 158 and the Redliner application 132, with processor(s), memory, input device(s), output device(s), network interfaces, and wireless transceivers of a computing device. Operating system may be an operating system designed to be installed on laptops and desktops. For example, operating system 312 may be a Windows operating system, Linux, or Mac OS. In another example, if computing device is a mobile device, such as a smartphone or a tablet, operating system may be one of Android, iOS or a Windows mobile operating system.

Applications may be any applications implemented within or executed by computing device and may be implemented or contained within, operable by, executed by, and/or be operatively/communicatively coupled to components of computing device. Applications may include instructions that may cause processor(s) of computing device to perform particular functions. Applications may include algorithms which are expressed in computer programming statements, such as, for-loops, while-loops, if-statements, do-loops, etc. Applications may be developed using a programming language. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, Python, UNIX Shell, Visual Basic or Visual Basic Script, Virtual Reality Markup Language (VRML), ColdFusion™ and other compilers, assemblers, and interpreters.

The term “usage” can mean both expected wheelchair usage (i.e., route planning) and actual wheelchair usage (i.e., as captured by sensor data 114, 134)) depending on the context. Although handheld devices such as mobile phones 104 that are easily carried are anticipated as being particularly useful as a remote device to which sensor data 114, 132 is transmitted and/or processed, it is not a strict requirement that a handheld device must be utilized. Other devices such as desktop computers (e.g., home computer 170) that are of a more permanent nature may also act as remote device to which sensor data 114, 132 is received and/or processed in conjunction with the invention.

Route planning such as illustrated in FIG. 9 and FIG. 10, for example, can also be independently performed regardless of whether actual wheelchair usage is monitored and/or recommended wheelchair settings are stored on a user by user basis. For instance, a simple web application may be deployed in another embodiment, where a user simply inputs their current RAP setting (or current experience level) and the webserver 158 and/or Redliner application 132 generates a recommended route 902 that is compliant with the user's inputted RAP setting—see FIG. 9. Alternatively, the user may input a predetermined route 1002 such as shown in FIG. 10 along with their current RAP setting (or current experience level), and the webserver 158 and/or Redliner application 132 then checks the predetermined route 1002 and informs the user of whether or not the route is possible with the user's chosen RAP setting.

In yet another example modification, a motorized actuator may be provided on the wheelchair 200 that receives the setting change messages and automatically makes the setting change. For instance, assuming the user agrees with a newly recommended RAP setting, the monitoring server 104 may be configured at step 710 to issue a RAP setting change message to the motorized actuator on the wheelchair 200, either directly or via the Redliner application 132 running on the user's mobile phone 104. The motorized actuator then changes the position of the rear axle 216 to match the newly recommended RAP setting. Similar motorized actuators may be included to automatically change settings of other wheelchair settings such as seat angle etc.

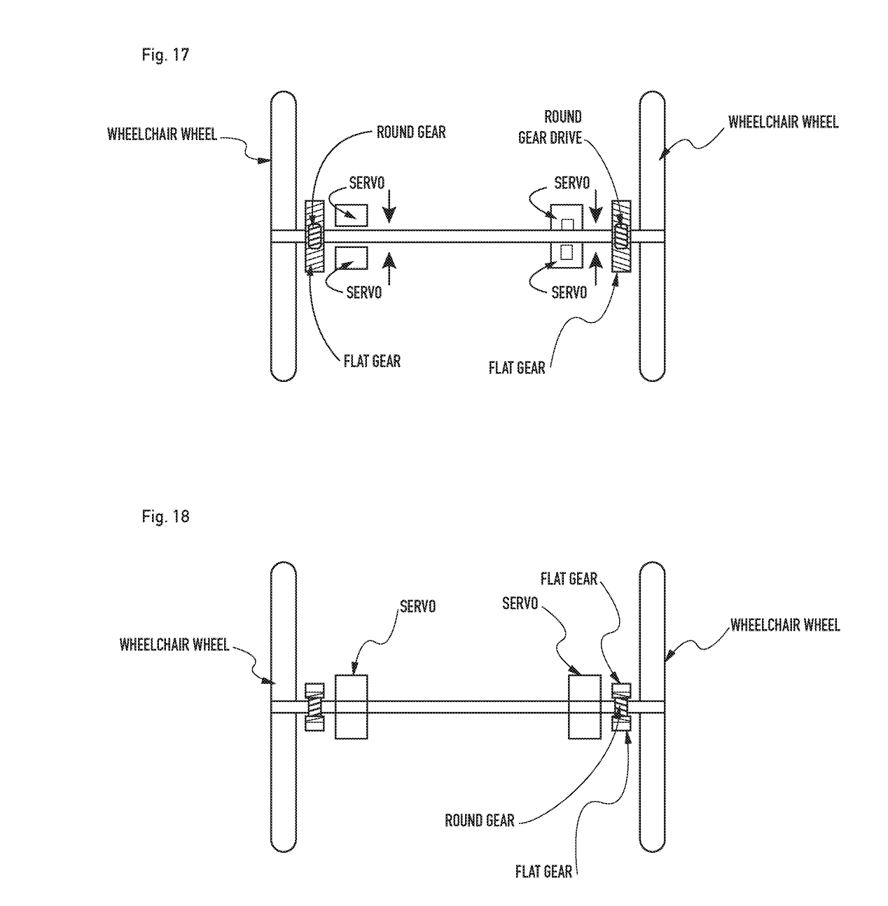

FIG. 17 shows a top down view of a servo driven adjustable RAP system according to an exemplary embodiment, and FIG. 18 shows a front on view of the servo driven adjustable RAP system of FIG. 17. As illustrated, the rear axle has a round gear on each end that engages with flat gear both above and below the round gear and coupled to the wheel chair frame. Servos on each side of the rear axle move the rear axle into position. The servos may operate in response to the setting change messages in order to automatically put into place recommended RAP settings. This may happen while the user is using the chair 200 but after the user has specifically agreed to the recommended setting in some embodiments.

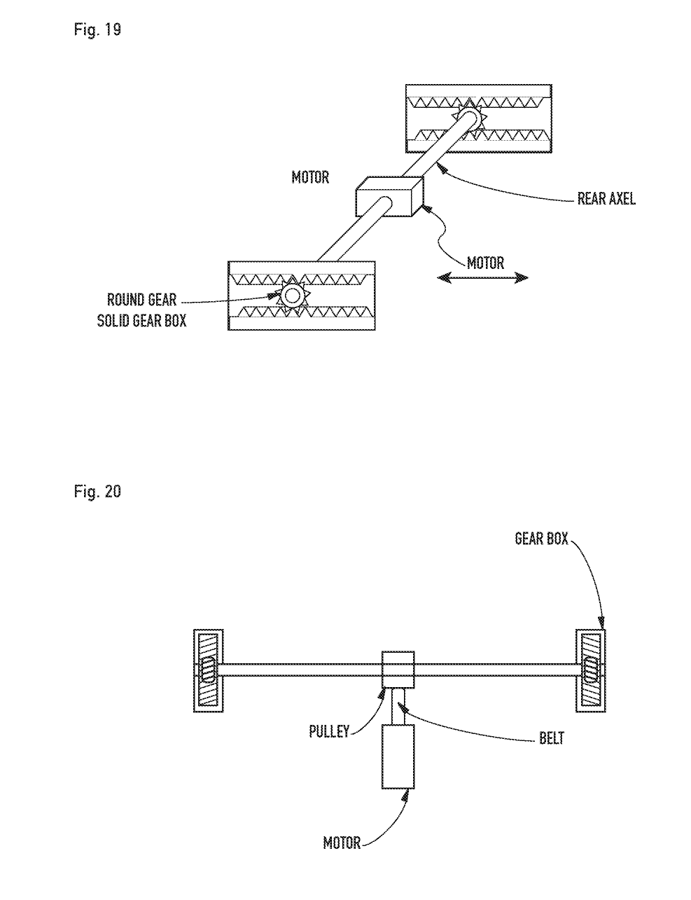

FIG. 19 shows a first side view of a belt driven adjustable RAP system according to an exemplary embodiment, and FIG. 20 shows a second side view of the belt driven adjustable RAP system of FIG. 19. As illustrated, in this example, a motor drives the rear axle for movement forwards and back. A pulley and/or belt couples the motor to the rear axle instead of the servos done in FIG. 17. Similar to in the previous example, the motor may operate in response to setting change messages in order to automatically set the recommended RAP settings.

In addition to the Redliner sensor system and the RAP Redliner application 132, in other embodiments, users can be offered a choice of a wheelchair that allows them to change RAP easily and in real-time, according the setting change messages received from the neural network 160 or even other times when they see it necessary; for example, the person has set the RAP in a very stable point but when facing a curb, he/she temporarily sets the RAP to a tippy point so that he could pass the curb.

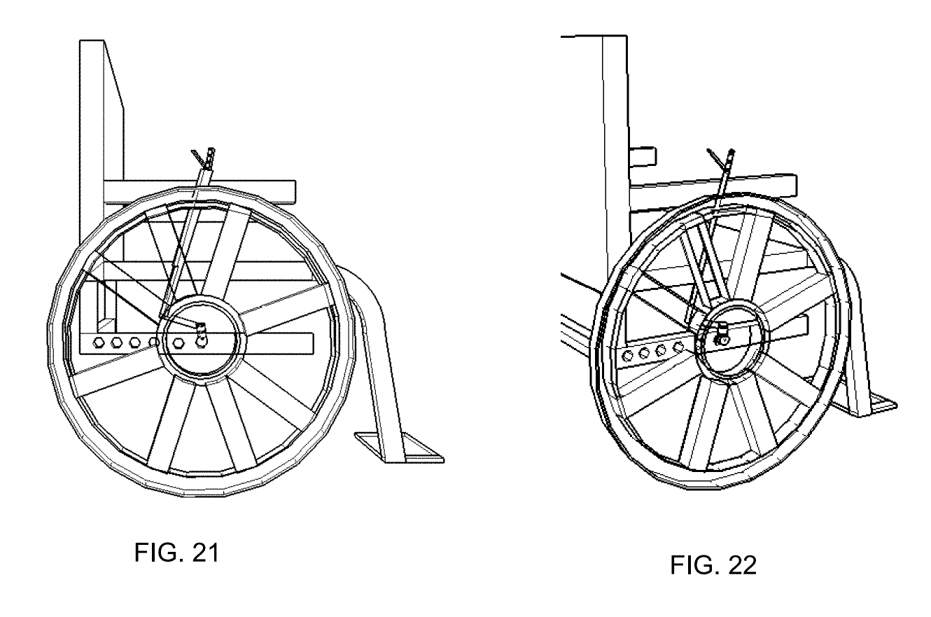

Manual adjustment of wheelchair settings including RAP settings is also possible. For instance, FIG. 21 illustrates a side view of a wheelchair with a manually adjustable RAP setting, and FIG. 22 illustrates an isometric view of the wheelchair of FIG. 21. As illustrated, the wheelchair includes a lever mechanism that allows the person to change the RAP setting manually by operation of the lever while seated on the chair. The person may follow the recommendations of the Redliner application 132 or may make changes themselves at any time. A RAP sensor 117 may also be incorporated into any of the automatic or manually adjustable wheelchairs of FIG. 17-22 in order to allow the sensor data 114 passed to the neural network 160 to include the current RAP setting.

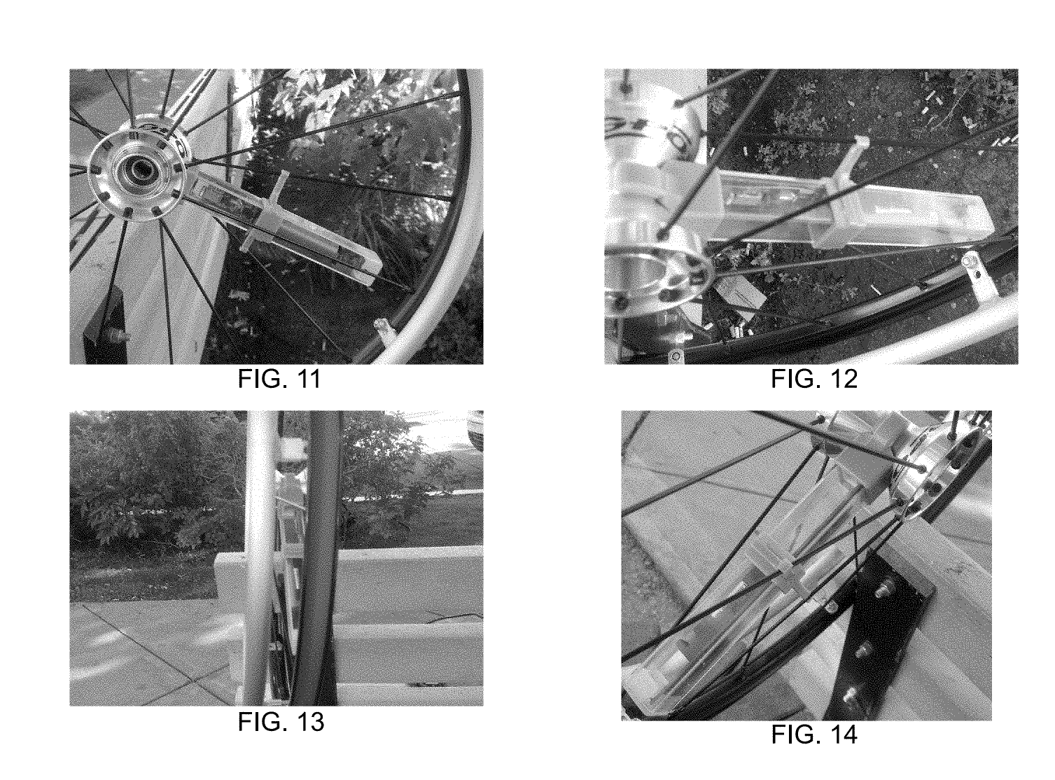

Different enclosures and mounting systems for mounting the sensor system 102 to a wheelchair wheel 204 may be developed. For instance, FIGS. 11-14 shows different views of a universal mounting system comprising a clip that mounts to the hub of the wheel, and a spanner that attaches to two spokes.

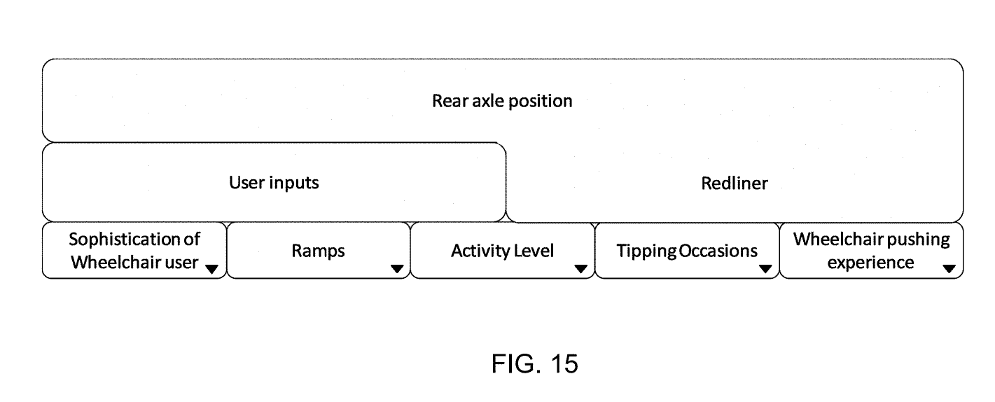

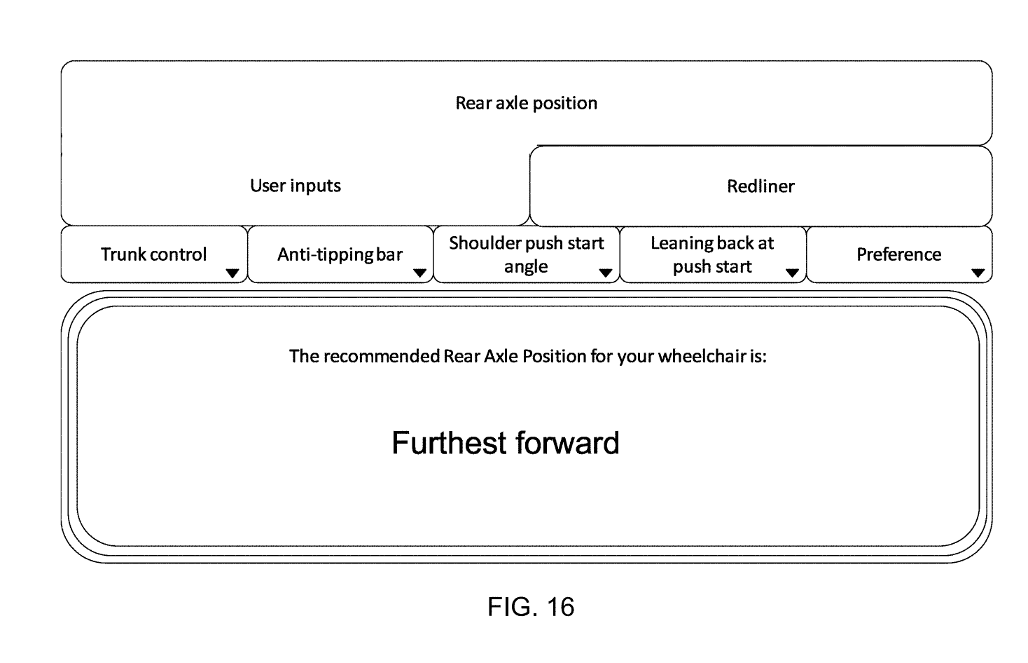

Different UI screens may be deployed to allow the user to input information and view recommendations. As examples, FIG. 15 shows a UI screen allowing a user to input information that can be utilized by the neural network 160 in order to determine recommended wheelchair setting(s). FIG. 16 shows another UI screen allowing the user to view various representations of the sensor data 114, 132 along with the recommended RAP setting recommended by the neural network 160.

In some embodiments, a neural network 160 is utilized by the monitoring server 106 at step 706 to process the various factors affecting the recommended RAP setting. Utilizing a neural network 160 may be advantageous because there are standard tools available to develop and deploy them. For instance, MATLAB allows the design of neural networks to weigh a plurality of input variables and generate an output value such as the recommended RAP setting. After the neural network 160 is designed and tested, MATLAB allows automatic exporting of the neural network to form a run time version in a computer language of choice. For example, the run time version of the neural network 160 can be exported as a C programming file, a python file, etc. This allows the neural network 160 to very easily be incorporated for use by a webserver 158. However, in other embodiments, any computer algorithm regardless of whether the algorithm is implemented as a neural network can be utilized by the monitoring server 106 at step 706 to process the various factors affecting the recommended RAP setting.

The various application programs may be implemented by software executed by one or more processors operating pursuant to instructions stored on a tangible computer-readable medium such as a storage device to perform the above-described functions of any or all aspects of the access controller. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes any of the above-described units as a result of executing the instructions.

In other embodiments, rather than being software modules executed by one or more processors, the modules may be implemented as hardware modules configured to perform the above-described functions. Examples of hardware modules include combinations of logic gates, integrated circuits, field programmable gate arrays, and application specific integrated circuits, and other analog and digital circuit designs. Functions of single modules and devices may be separated into multiple units, or the functions of multiple modules and devices may be combined into a single unit.

Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above-described features and embodiments may be utilized in conjunction with the invention.

### Appendix A—PatternNet_AttachmentA.m

| | | | | | | | | | | | | | |
|---|---|---|---|---|---|---|---|---|---|---|---|---|---|
| x =[2 | 2 | 2 | 2 | 3 | 3 | 1 | 1 | 3 | 3 | 3 | 3 | 1 | 1 |
| 2 | 2 | 2 | 2 | 2 | 2 | 1 | 1 | 1 | 1 | 2 | 2 | 2 | 1 |
| 1 | 1 | 1 | 1 | 1 | 1 | 3 | 2 | 2 | 2 | 2 | 1 | 3 | 3 |
| 1 | 1 | 1 | 1 | 1 | 1 | 2 | 2 | 2 | 2 | 2 | 1 | 2 | 2 |
| 1 | 1 | 1 | 1 | 2 | 2 | 1 | 2 | 2 | 2 | 2 | 1 | 1 | 2 |
| 1 | 2 | 3 | 3 | 1 | 2 | 3 | 2 | 1 | 2 | 1 | 1 | 2 | 3 |
| 1 | 1 | 1 | 1 | 2 | 2 | 3 | 3 | 3 | 2 | 3 | 3 | 3 | 1 |
| 1 | 1 | 1 | 1 | 3 | 3 | 2 | 2 | 2 | 3 | 2 | 1 | 2 | 3 |
| 1 | 1 | 2 | 3 | 1 | 1 | 1 | 2 | 3 | 2 | 3 | 3 | 1 | 1 |
| 1 | 2 | 3 | 3 | 1 | 1 | 3 | 2 | 2 | 2 | 2 | 1 | 2 | 3 |
| ] ; | | | | | | | | | | | | | |
| t=[0 | 0 | 0 | 1 | 0 | 0 | 0 | 0 | 0 | 0 | 1 | 1 | 0 | 0 |
| 1 | 1 | 1 | 0 | 1 | 0 | 0 | 1 | 1 | 0 | 0 | 0 | 1 | 0 |
| 0 | 0 | 0 | 0 | 0 | 1 | 1 | 0 | 0 | 1 | 0 | 0 | 0 | 1 |

];
net = patternnet(10);
net = train(net,x,t);
% view(net)
y = net(x);
perf = perform(net,t,y);
classes = vec2ind(y);

| | | | | | | | | | | | | |
|---|---|---|---|---|---|---|---|---|---|---|---|---|
| Diff=[2 | 2 | 2 | 1 | 2 | 3 | 3 | 2 | 2 | 3 | 1 | 1 | 2 |

3]-classes

% max_fail=30;

### Appendix B—Test_AttachmentB.m

```
yy=[1
1
1
1
1
1
1
1
1
1
];
rap= vec2ind(net(yy));
if rap==1
  RAP=‘farthest back’
elseif rap==2
  RAP=‘middle’
else
  RAP=‘farthest forward’
End
```

What is claimed is:

1. A system for recommending changes to a wheelchair configuration setting, the system comprising:
a portable electronic device having at least one sensor collecting a plurality of sensor data corresponding to movement of a wheelchair; and
one or more processors coupled to a storage device and a communication interface;
wherein, by the one or more processors executing software instructions loaded from the storage device, the one or more processors are operable to:
receive the sensor data from the portable electronic device via the communication interface;
generate a recommended wheelchair setting for the wheelchair based at least in part on the sensor data;
compare the recommended wheelchair setting with a current wheelchair setting associated with the wheelchair stored in the storage device; and
transmit a setting change message via the communication interface when the recommended wheelchair setting is different than the current wheelchair setting.

2. The system of claim 1, wherein the setting change message comprises a web page generated by a webserver in response to a user associated with the wheelchair logging in to the webserver.

3. The system of claim 1, wherein the one or more processors are further operable to transmit the setting change message in real time in response to determining that the recommended wheelchair setting is different than the current wheelchair setting.

4. The system of claim 1, wherein the one or more processors are further operable to:
store the sensor data in the storage device to thereby build a history of sensor data associated with the wheelchair over time; and
generate the recommended wheelchair setting based at least in part on the history of sensor data.

5. The system of claim 1, wherein:
the storage device comprises a neural network trained for a type of the wheelchair; and
the one or more processors are further operable to generate the recommended wheelchair setting at least in part by running the sensor data through the neural network.

6. The system of claim 5, wherein the storage device further includes a plurality of neural networks trained for a plurality of different types of wheelchairs.

7. The system of claim 1, wherein the one or more processors are further operable to:
receive a route planning request with a desired origin and a desired destination via the communication interface;
analyse a plurality of map data according to the desired origin and desired destination in conjunction with the current wheelchair setting;
generate a recommended route from the desired original to the desired destination that does not require a change to the current wheelchair setting; and
transmit a route planning message including the recommended route via the communication interface.

8. The system of claim 7, wherein, when analysing the map data, the one or more processors are operable to search for the recommended route that avoids obstacles needing to be traversed by the wheelchair that would exceed a difficulty level of the current wheelchair setting.

9. The system of claim 1, wherein the one or more processors are further operable to:
receive a route planning request with a predetermined route via the communication interface;
analyses a plurality of map data according to the predetermined route in order to determine a required wheelchair setting;
compare the required wheelchair setting with the current wheelchair setting; and
transmit a route planning message via the communication interface with a warning when the required wheelchair setting exceeds a difficulty level of the current wheelchair setting.

10. The system of claim 9, wherein, when analysing the map data in order to determine the required wheelchair setting, the one or more processors are operable to determine an obstacle with a greatest difficulty level needing to be traversed by the wheelchair in order to travel along the predetermined route.

11. The system of claim 1, wherein:
the current wheelchair setting corresponds to a current rear axle position of the wheelchair; and
the recommended wheelchair setting corresponds to a recommended rear axle position.

12. The system of claim 1, wherein:
the portable electronic device is a sensor system attached to a wheel of the wheelchair; and
at least a part of the sensor data corresponds to the sensor system tracking motion of the wheel over time.

13. The system of claim 12, wherein the sensor system includes at least two accelerometers located at different radial distances from a center point of the wheel.

14. The system of claim 1, wherein:
the portable electronic device includes a global positioning system (GPS) receiver; and
at least a part of the sensor data corresponds the global positioning system (GPS) receiver tracking location of the wheelchair over time.

15. A method of recommending changes to a wheelchair configuration setting, the method comprising:
collecting a plurality of sensor data corresponding to movement of a wheelchair;
generating a recommended wheelchair setting for the wheelchair based at least in part on the sensor data;
comparing the recommended wheelchair setting with a current wheelchair setting associated with the wheelchair stored in the storage device; and
transmitting a setting change message via a communication interface when the recommended wheelchair setting is different than the current wheelchair setting.

16. The method of claim 15, further comprising generating the setting change message as a web page in response to a user associated with the wheelchair logging in to a webserver.

17. The method of claim 15, further comprising transmitting the setting change message in real time in response to determining that the recommended wheelchair setting is different than the current wheelchair setting.

18. The method of claim 15, further comprising:
storing the sensor data in a storage device to thereby build a history of sensor data associated with the wheelchair over time; and
generating the recommended wheelchair setting based at least in part on the history of sensor data.

19. The method of claim 15, further comprising:
receiving a route planning request with a desired origin and a desired destination via the communication interface;
analysing a plurality of map data according to the desired origin and desired destination in conjunction with the current wheelchair setting;
generating a recommended route from the desired original to the desired destination that does not require a change to the current wheelchair setting; and
transmitting a route planning message including the recommended route via the communication interface.

20. A system for recommending changes to a wheelchair configuration setting, the system comprising:
a portable electronic device having at least one sensor collecting a plurality of sensor data corresponding to movement of a wheelchair; and
one or more processors coupled to a storage device and a communication interface;
wherein, by the one or more processors executing software instructions loaded from the storage device, the one or more processors are operable to:
receive the sensor data from the portable electronic device via the communication interface; and
generate a recommended wheelchair setting for the wheelchair based at least in part on the sensor data.
